(19) United States
(12) Patent Application Publication
(10) Pub. No.: US 2026/0010466 A1
(43) Pub. Date: Jan. 8, 2026

(54) STORAGE DEVICE INCLUDING VOLATILE MEMORY AND OPERATING METHOD THEREOF

(71) Applicant: SK hynix Inc., Gyeonggi-do (KR)

(72) Inventors: Dong-Gun KIM, Gyeonggi-do (KR); Nam Hyun YUN, Gyeonggi-do (KR); Hyeong Ju NA, Gyeonggi-do (KR); Dong Sop LEE, Gyeonggi-do (KR)

(21) Appl. No.: 18/977,900

(22) Filed: Dec. 11, 2024

(30) Foreign Application Priority Data
Jul. 8, 2024 (KR) 10-2024-0089494

(51) Int. Cl. G06F 12/02

(52) U.S. Cl. CPC G06F 12/0223

(57) ABSTRACT

A storage device comprising a volatile memory comprising a plurality of physical areas, a compression operation component configured to compress write data at a first ratio to generate first compressed data, and a control operation component configured to set the plurality of physical areas included in the volatile memory as first physical areas and second physical areas, set a first number of physical areas among the first physical areas as first storage areas to manage the first number of physical areas in a form of a linked list, store the first compressed data in the first storage areas, and store, in the second physical areas, first logical information indicating an area set as a header, among the first storage areas.

### CROSS-REFERENCE TO RELATED APPLICATION

This application claims priority under 35 U.S.C. § 119(a) to Korean Patent Application No. 10-2024-0089494, filed on Jul. 8, 2024, the entire contents of which are incorporated herein by reference.

### BACKGROUND

### 1. Field

Various embodiments of the present disclosure relate to a storage device, and more particularly, to a storage device including a volatile memory and an operating method thereof.

### 2. Discussion of the Related Art

Memory systems may refer to storage devices embodied using a semiconductor such as silicon (Si), germanium (Ge), gallium arsenide (GaAs), indium phosphide (InP), or the like. The memory systems are generally classified into volatile memory devices and nonvolatile memory devices. A volatile memory device is configured to lose data stored therein when power supply is interrupted. Representative examples of the volatile memory device include a static RAM (SRAM), a dynamic RAM (DRAM), a synchronous DRAM (SDRAM), etc. A nonvolatile memory device is configured to retain data stored therein even when power supply is interrupted. Representative examples of the nonvolatile memory device include a read only memory (ROM), a programmable ROM (PROM), an electrically programmable ROM (EPROM), an electrically erasable programmable ROM (EEPROM), a flash memory, a phase-change random access memory (PRAM), a magnetic RAM (MRAM), a resistive RAM (RRAM), a ferroelectric RAM (FRAM), etc. Flash memories may include a NOR-type flash memory and a NAND-type flash memory.

A storage device may further include a controller (i.e., a memory controller) for controlling a memory (for example, a volatile memory/a nonvolatile memory), and such a controller may receive a command from an external device (i.e., a host), and perform data read, write, and erase operations on a memory included in the storage device based on the received command or control the operations.

On the other hand, the size of memory capacity required in a computing system continues to increase. In particular, in the case of a volatile memory having a higher price per capacity than a nonvolatile memory, increasing the size of memory capacity is more difficult.

Therefore, a method for compressing and storing data stored in the volatile memory included in the storage device has been proposed.

### SUMMARY

Various embodiments of the present disclosure are directed to providing a storage device capable of compressing write data and storing the compressed data in a volatile memory and an operating method thereof.

Technical problems to be solved by the present disclosure are not limited to the aforementioned technical problems and the other unmentioned technical problems will be clearly understood by those skilled in the art from the following description.

In an embodiment of the present disclosure, a storage device may include: a volatile memory comprising a plurality of physical areas; a compression operation component configured to compress write data at a first ratio to generate first compressed data; and a control operation component configured to set the plurality of physical areas included in the volatile memory as first physical areas and second physical areas, set a first number of physical areas among the first physical areas as first storage areas to manage the first number of physical areas in a form of a linked list, store the first compressed data in the first storage areas, and store, in the second physical areas, first logical information indicating an area set as a header, among the first storage areas.

In an embodiment of the present disclosure, an operating method of a storage device including a volatile memory, the operating method may include: setting a plurality of physical areas included in the volatile memory as first physical areas and second physical areas; and storing first compressed data obtained by compressing write data at a first ratio in first storage areas for managing the first number of physical areas among the first physical areas in a form of a linked list, and storing, in the second physical areas, first logical information indicating an area set as a header, among the first storage areas.

Embodiments of the present disclosure can set a plurality of physical areas included in a volatile memory inside a storage device as first physical areas for storing compressed data and second physical areas for storing logical information indicating the compressed data stored in the first physical areas, and manage the first physical areas and the second physical areas.

In addition, embodiments of the present disclosure can manage an area, where one compressed data is stored among the first physical areas, in a form of one linked list, and set logical information, which indicates compressed data stored in the second physical areas, to indicate a header area of the linked list.

Through this, logical information of a constant size can be generated and stored in the second physical areas regardless of the compression ratio of the compressed data. Accordingly, compressed data stored in the volatile memory can be effectively accessed even when the ratio of a space occupied by the second physical areas in the volatile memory is minimized.

### BRIEF DESCRIPTION OF THE DRAWINGS

FIGS. 1A to 1C are diagrams illustrating a configuration of a data processing system including a storage device in accordance with an embodiment of the present disclosure.

FIGS. 2A to 2H are diagrams for describing an operation of a storage device that stores compressed data in a volatile memory and manages the stored compressed data, in accordance with a first embodiment of the present disclosure.

FIGS. 3A to 3I are diagrams for describing an operation of a storage device that stores compressed data in a volatile memory and manages the stored compressed data, in accordance with a second embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language includes hardware—for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in this disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

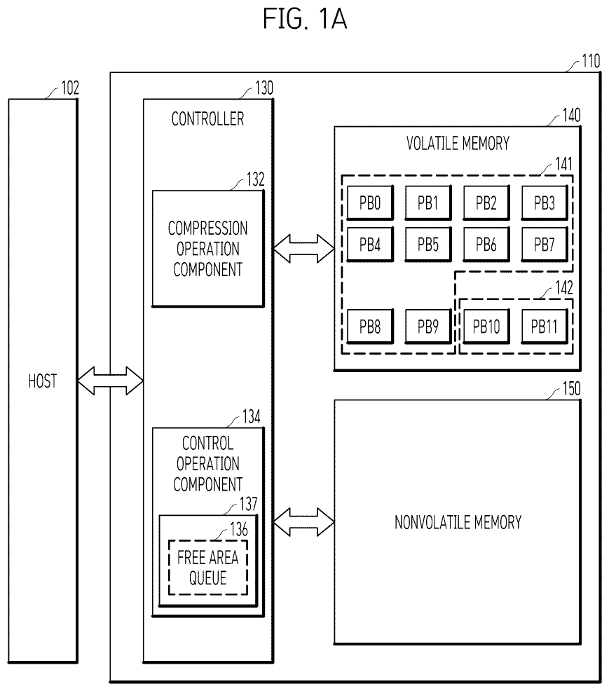

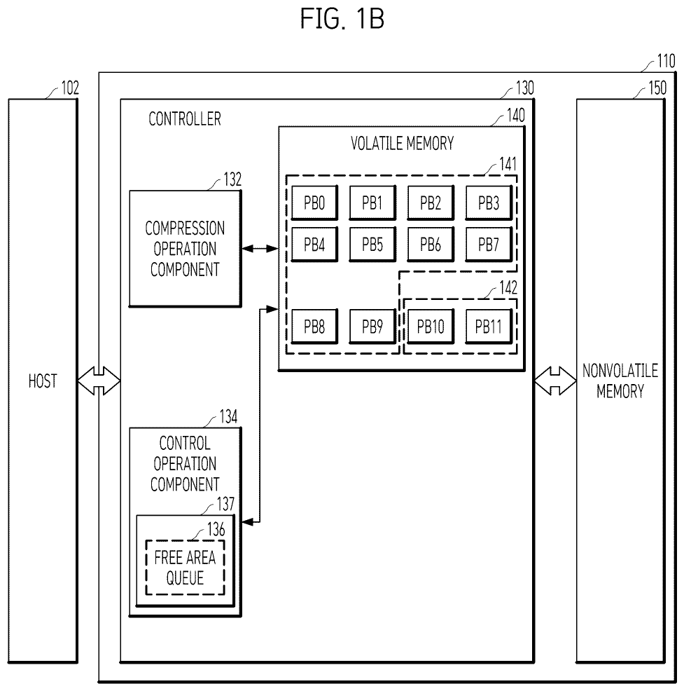

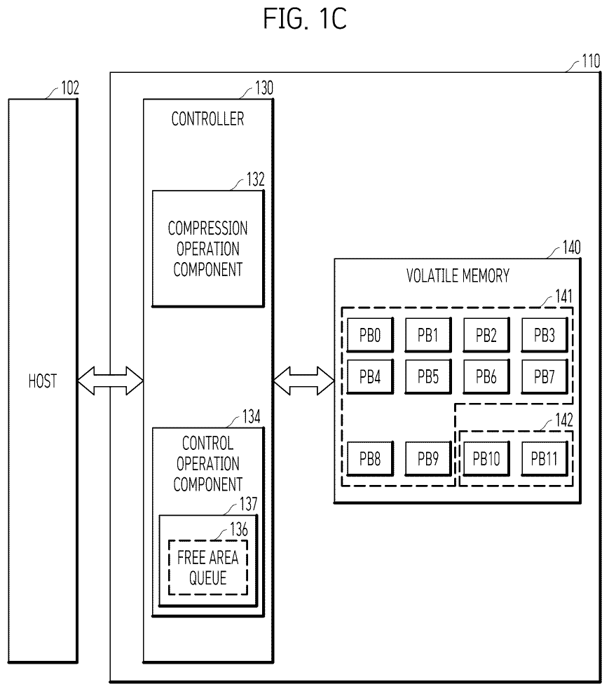

FIGS. 1A to 1C are diagrams for illustrating a configuration of a data processing system including a storage device 110 in accordance with an embodiment of the present disclosure.

Referring to FIG. 1A, the data processing system may include a host 102 engaged or coupled with a memory system (i.e., the storage device 110). For example, the host 102 and the storage device 110 can be coupled to each other via a data bus, a host cable and the like to perform data communication.

The storage device 110 may include memory devices (i.e., volatile memories 140 and 150) and a controller 130. The memory devices 140, 150 and the controller 130 in the storage device 110 may be considered components or elements physically separated from each other. The memory devices 140, 150 and the controller 130 may be connected via at least one data path. For example, the data path may include a channel and/or a way.

According to an embodiment, the memory devices 140, 150 and the controller 130 may be components or elements functionally divided. Further, according to an embodiment, The memory devices 140, 150 and the controller 130 may be implemented with a single chip or a plurality of chips. The controller 130 may perform a data input/output operation in response to a request input from the external device. For example, when the controller 130 performs a read operation in response to a read request input from an external device, data stored in a plurality of non-volatile memory cells included in the memory devices 140, 150 is transferred to the controller 130.

The controller 130 may control the memory devices 140 and 150 to perform read, program and erase operations corresponding to commands inputted from the host 102, and the storage device 110 may independently perform the operations regardless of commands inputted from an external device such as the host 102.

Specifically, the memory devices 140 and 150 may include a volatile memory 140 and a nonvolatile memory 150.

In addition, the controller 130, the volatile memory 140, and the nonvolatile memory 150 may be physically separate components. The controller 130 and each of the volatile memory 140 and the nonvolatile memory 150 may be connected through at least one data path. For example, the data path may include channels and/or ways.

The controller 130 may be independently connected to each of the volatile memory 140 and the nonvolatile memory 150. For example, a first data path may be connected between the volatile memory 140 and the controller 130, a second data path may be connected between the nonvolatile memory 150 and the controller 130, and the first data path and the second data path may be physically separate.

On the other hand, the storage device 110 according to an embodiment of the present disclosure may not only be configured in the form illustrated in FIG. 1A, but may also be configured in the forms illustrated in FIGS. 1B and 1C.

That is, as illustrated in FIG. 1B, the volatile memory 140 may be included inside the controller 130 and may be connected to other components 132 and 134 inside the controller 130 through a data bus, and the nonvolatile memory 150 may be configured to be connected through at least one data path outside the controller 130.

As illustrated in FIG. 1C, the storage device 110 may not include the nonvolatile memory 150, but may include only the volatile memory 140, and the volatile memory 140 may be connected to the controller 130 through a data path.

Referring to FIGS. 1A to 1C together, the storage device 110 according to an embodiment of the present disclosure may compress write data to generate compressed data, and manage the generated compressed data in the volatile memory 140. In such a case, the operation in which the volatile memory 140 manages the compressed data may mean that only the volatile memory 140 performs an access operation for the compressed data in a state in which the compressed data is stored in the volatile memory 140.

According to an embodiment, the write data may be data requested to be written from the host 102 to the storage device 110.

According to another embodiment, the write data may be data generated inside the controller 130 for the operation of the storage device 110.

In particular, even when the storage device 110 includes both the volatile memory 140 and the nonvolatile memory 150 as illustrated in FIGS. 1A and 1B, the storage device 110 according to an embodiment of the present disclosure may manage the compression data by using the volatile memory 140.

According to an embodiment, the storage device 110 may store the compressed data only in the volatile memory 140 without moving the compressed data to the nonvolatile memory 150, and then perform an access operation on the compressed data.

According to another embodiment, the storage device 110 stores the compressed data in both the nonvolatile memory 150 and the volatile memory 140, but stores the compressed data in the nonvolatile memory 150 for backup purposes. An access operation on the compressed data may be performed through the volatile memory 140.

Referring again to FIGS. 1A to 1C, the volatile memory 140 included in the storage device 110 may include a plurality of physical areas PB<0:11>.

The controller 130 included in the storage device 110 may include a compression operation component 132 and a control operation component 134.

The control operation component 134 may include an internal memory 137 including a space for storing a free area queue 136. The internal memory 137 may have a relatively higher operating speed than the volatile memory 140. According to an embodiment, when the volatile memory 140 is DRAM, the internal memory 137 may be SRAM.

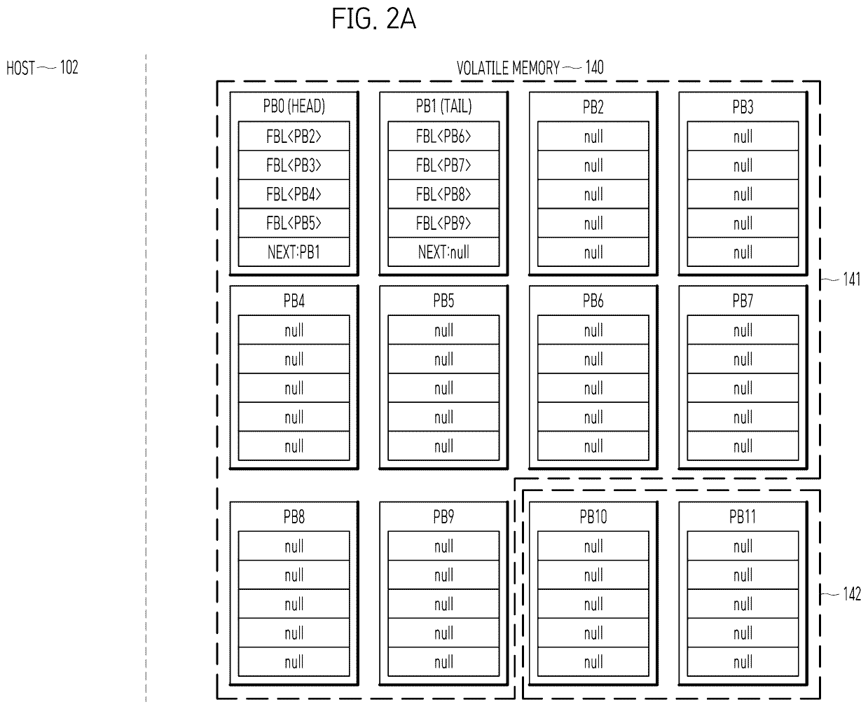

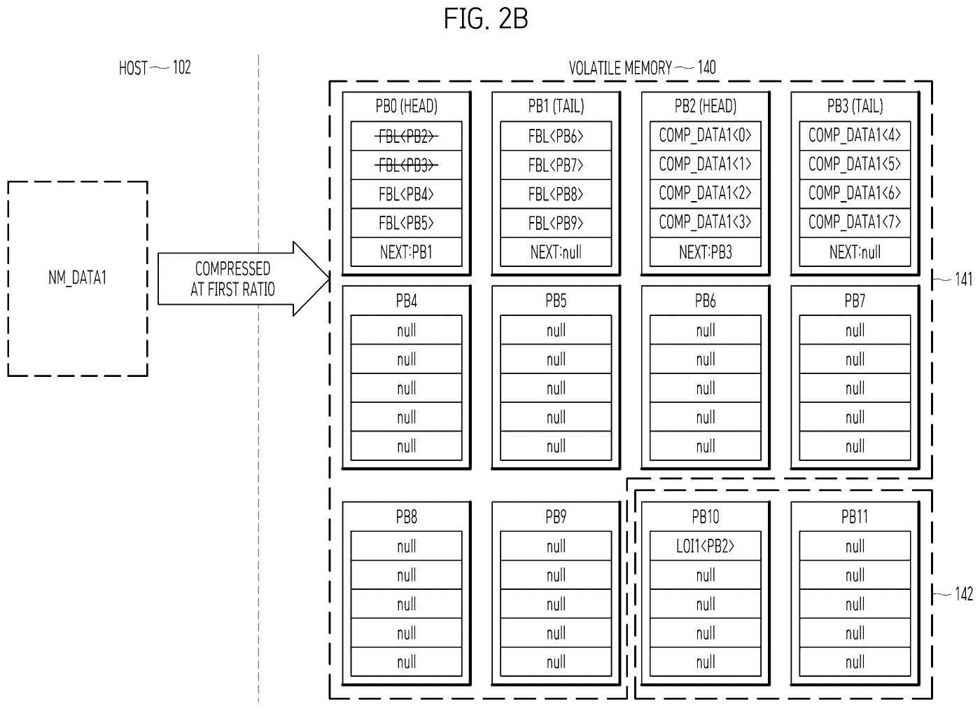

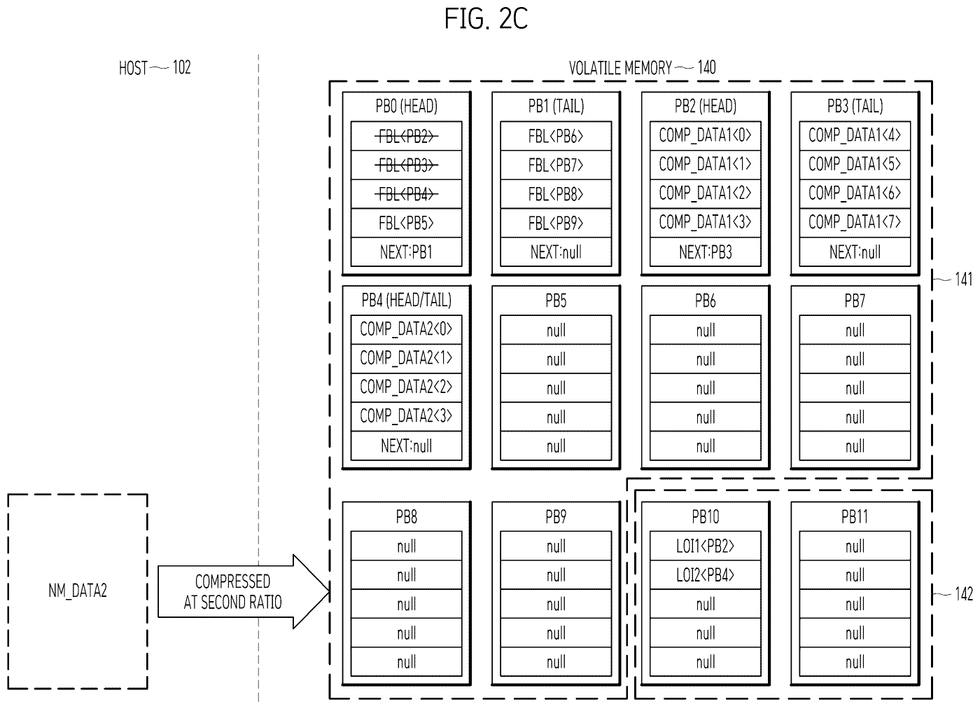

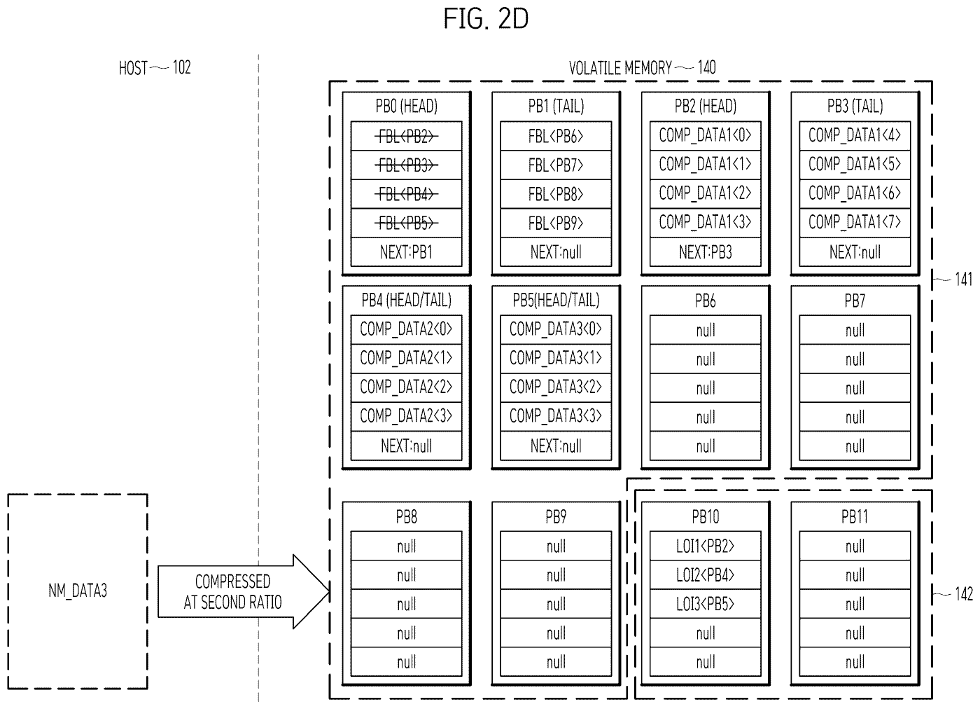

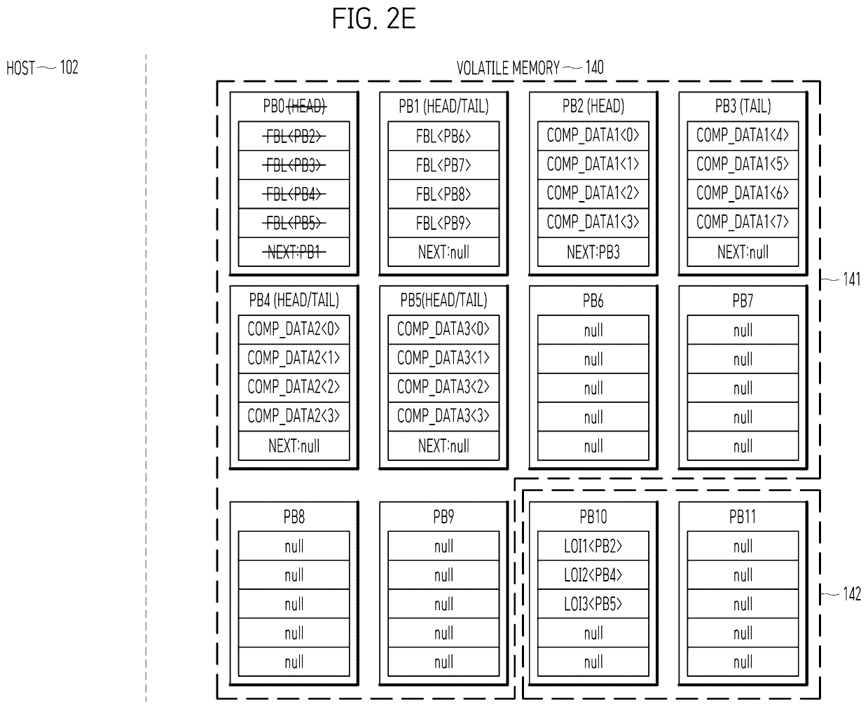

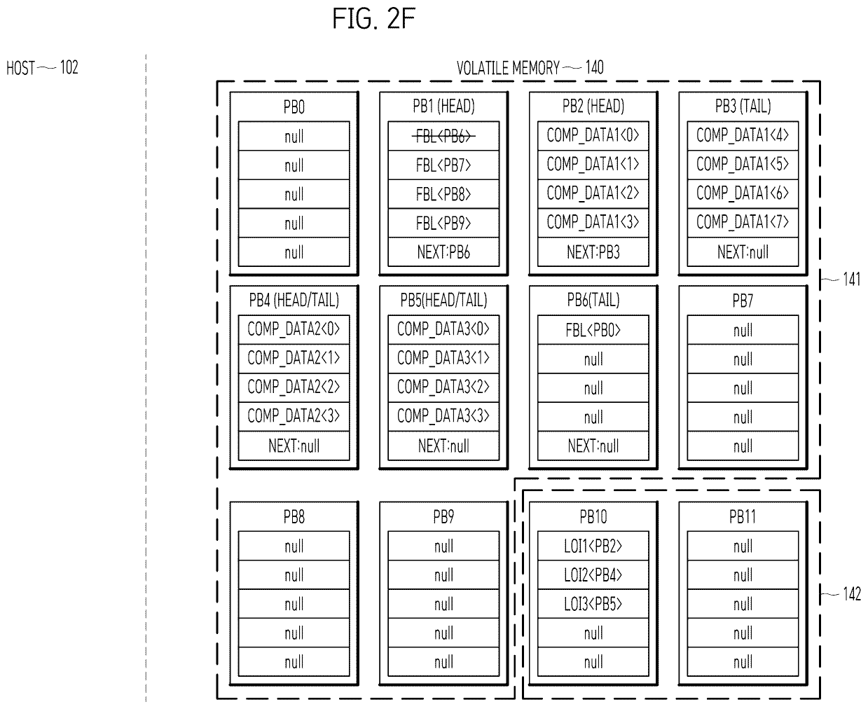

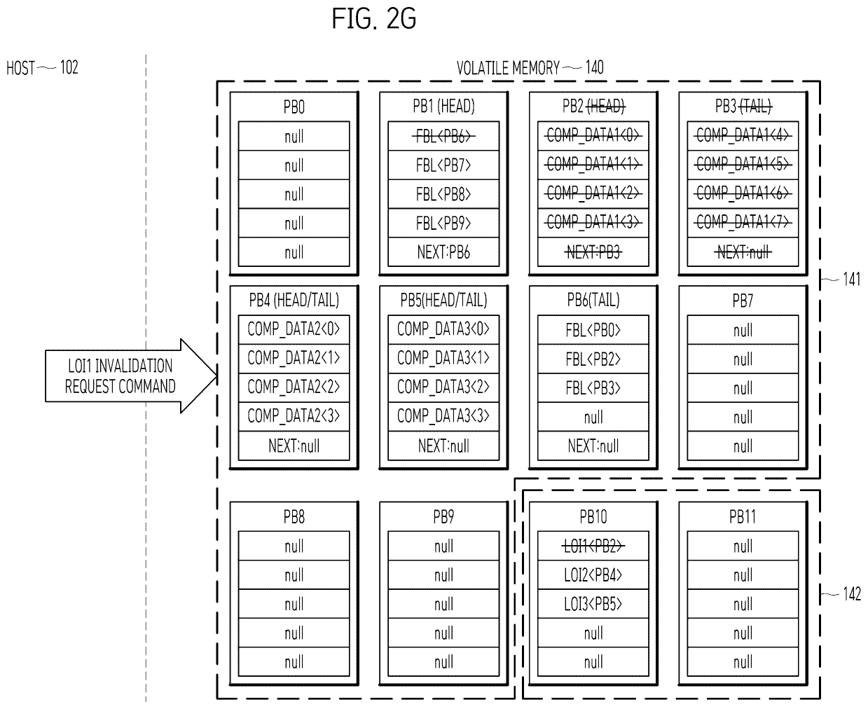

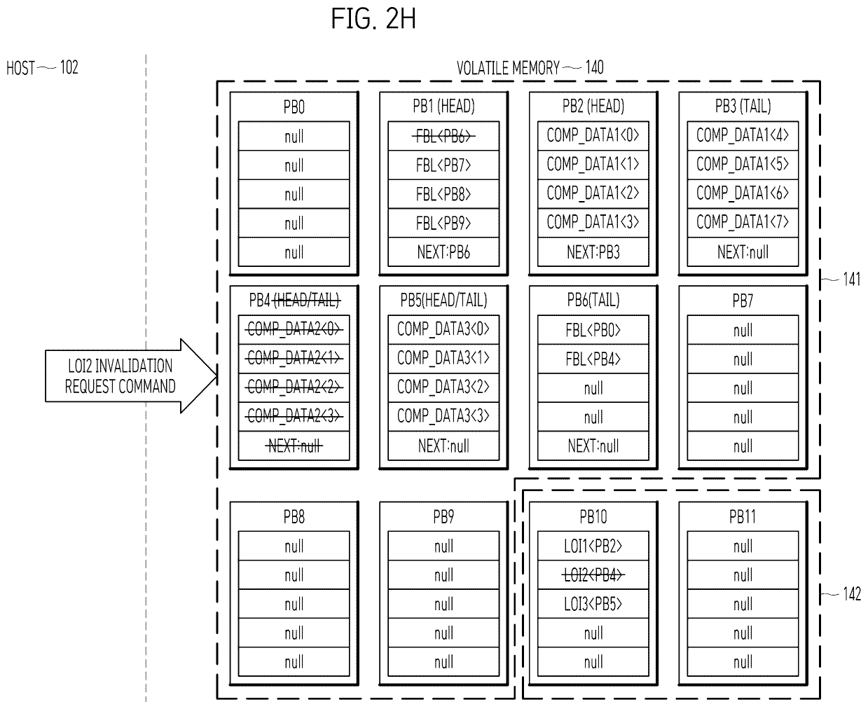

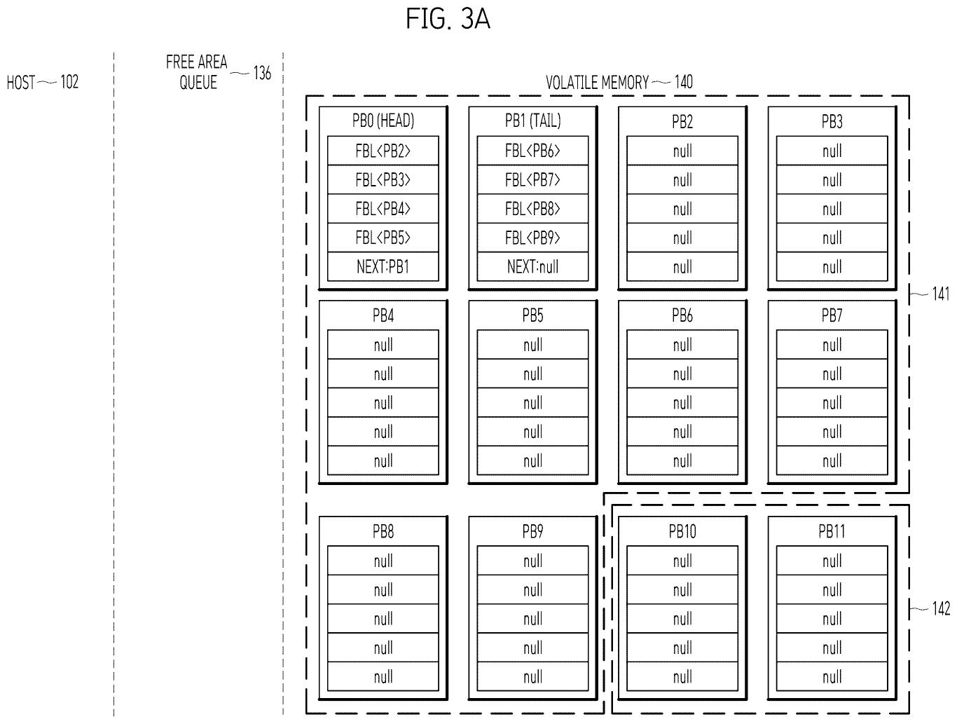

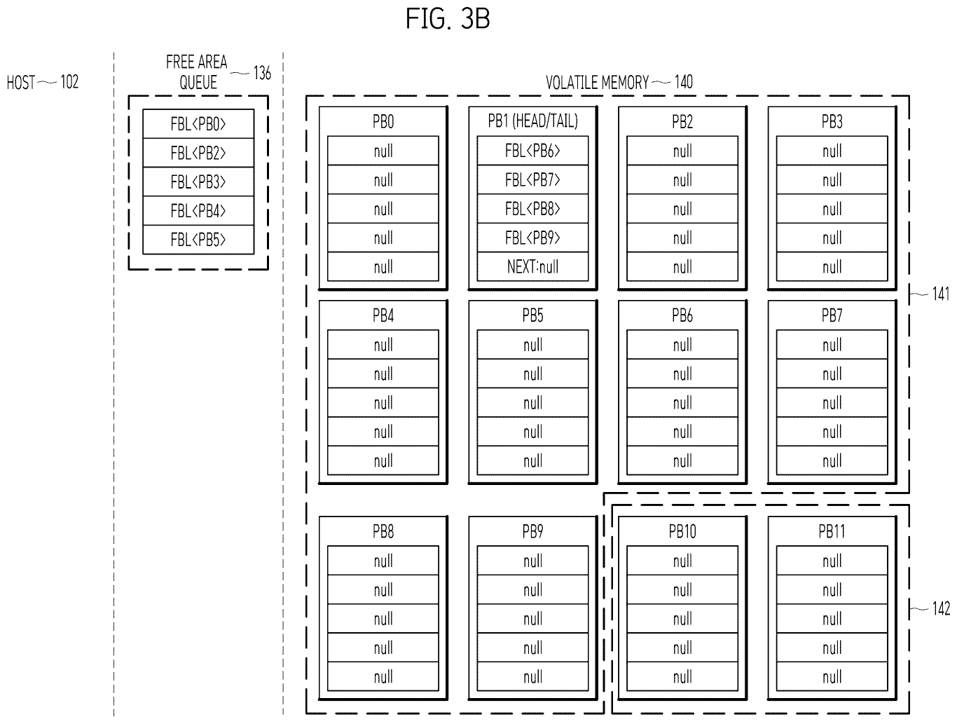

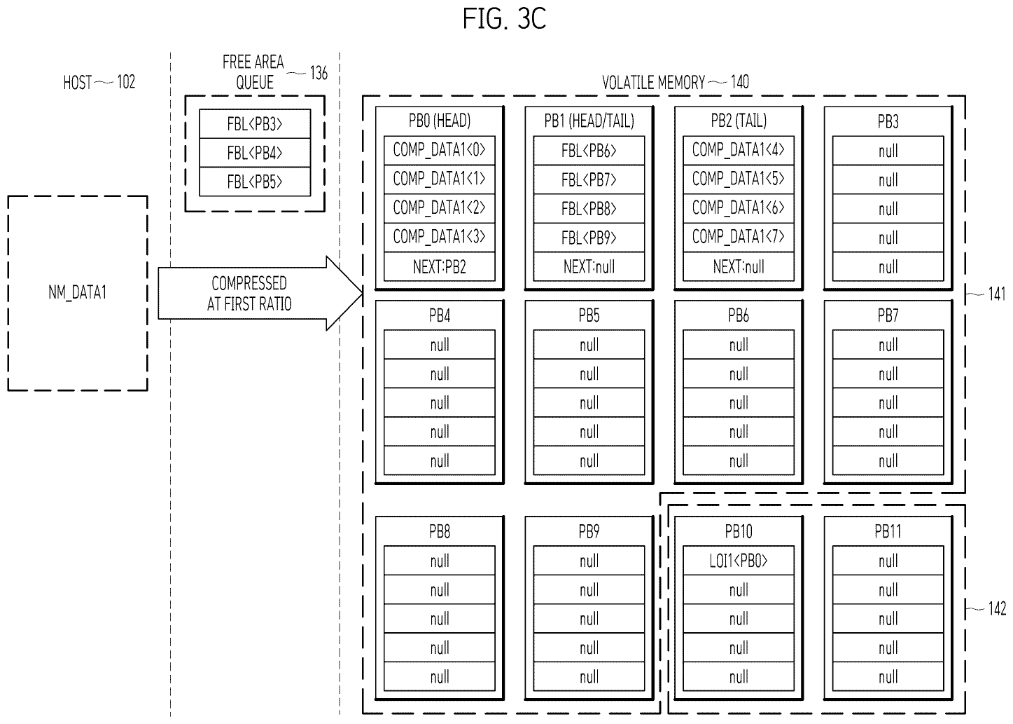

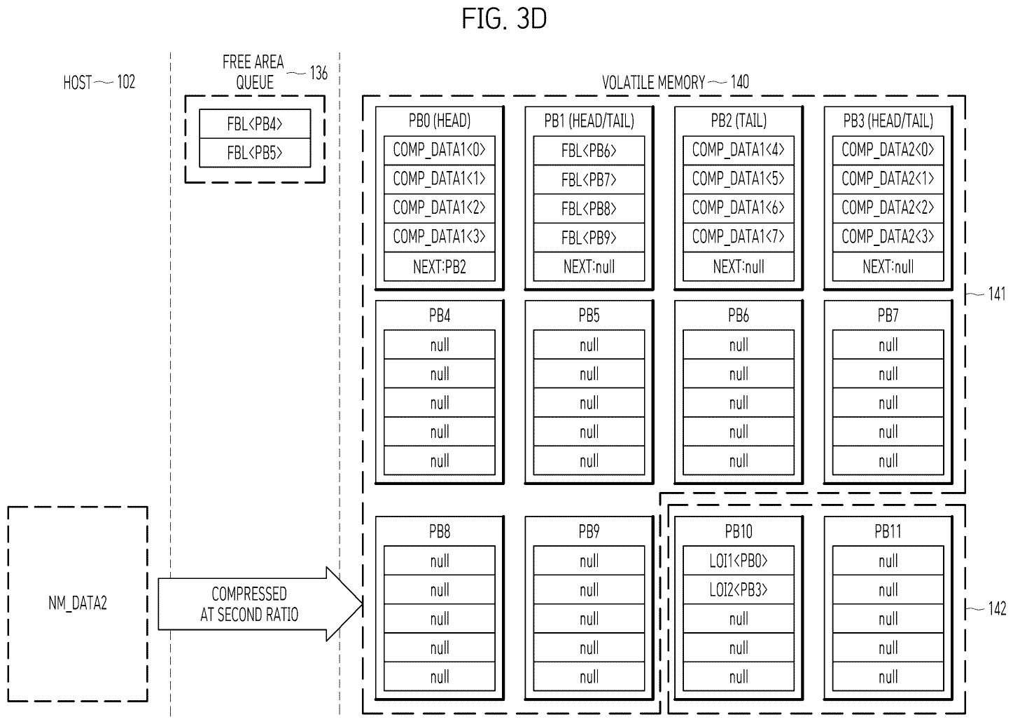

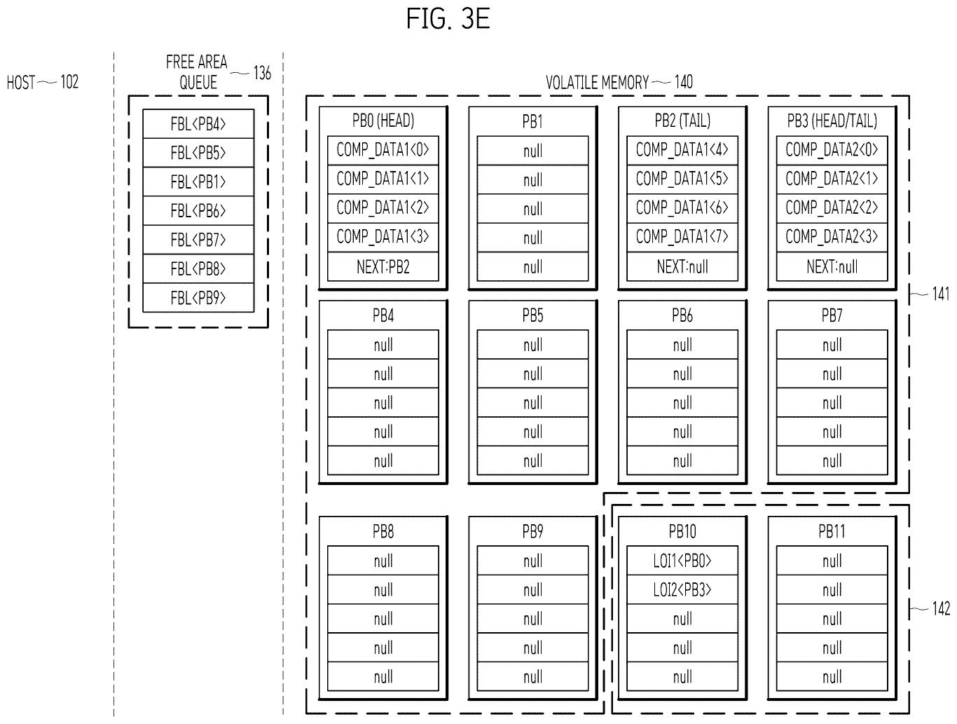

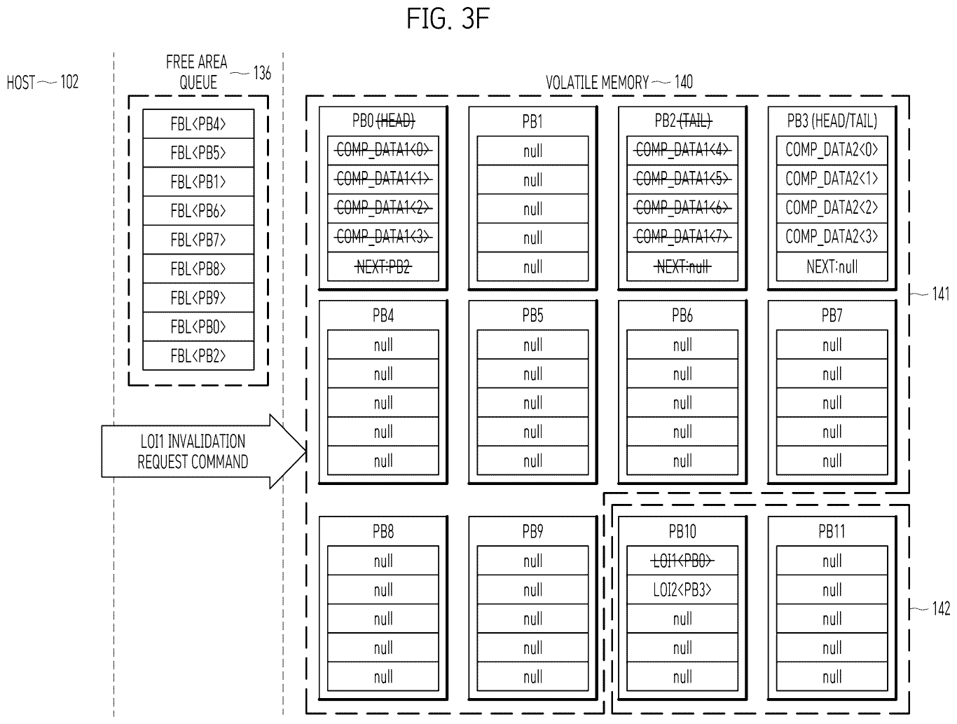

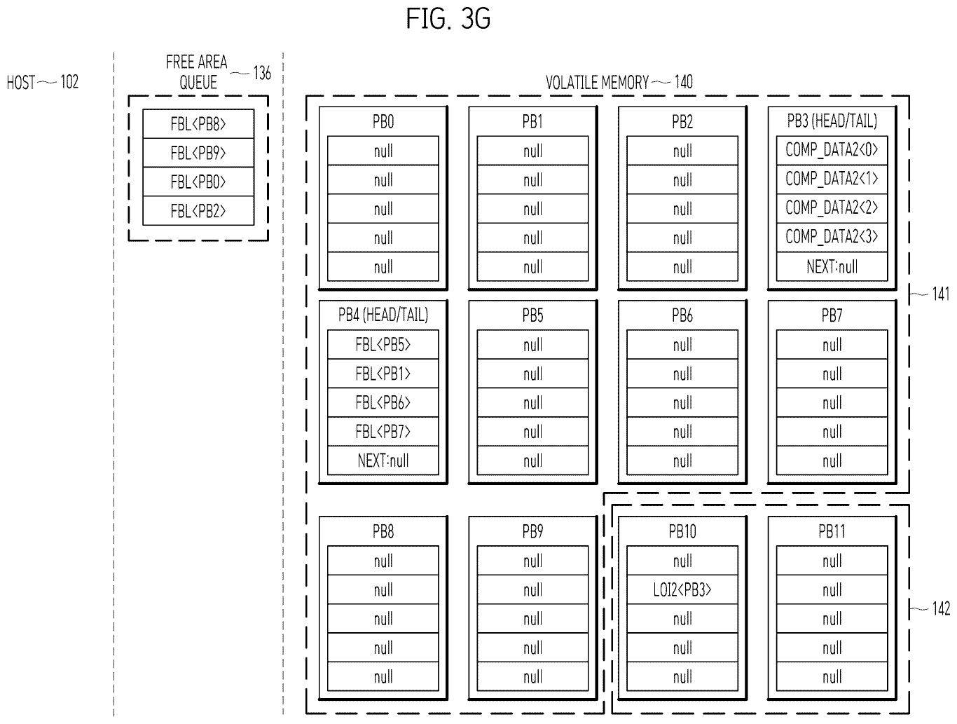

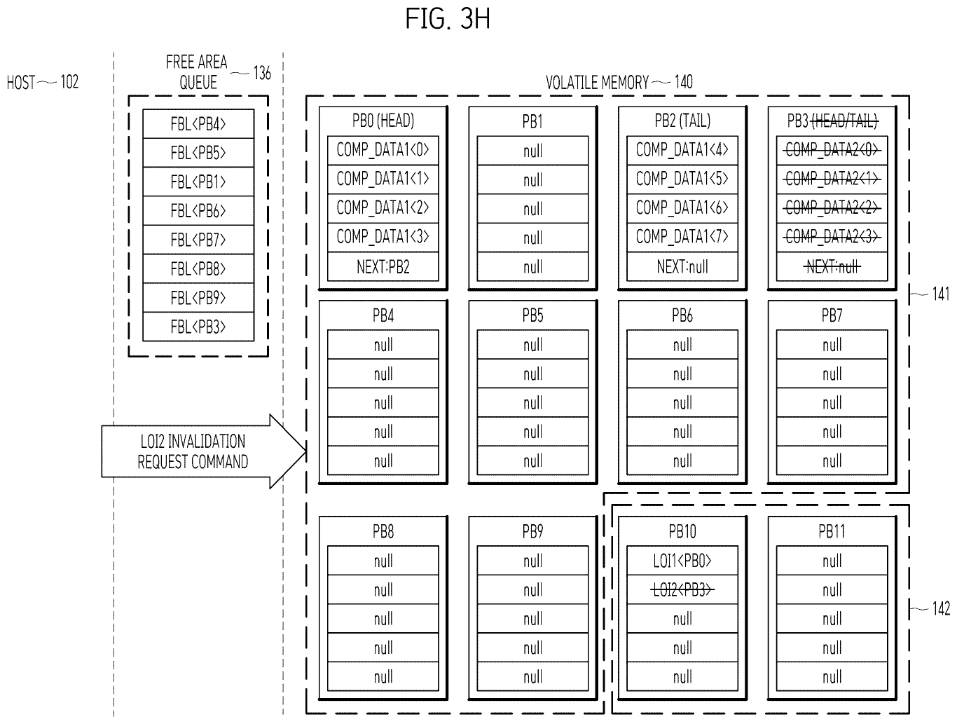

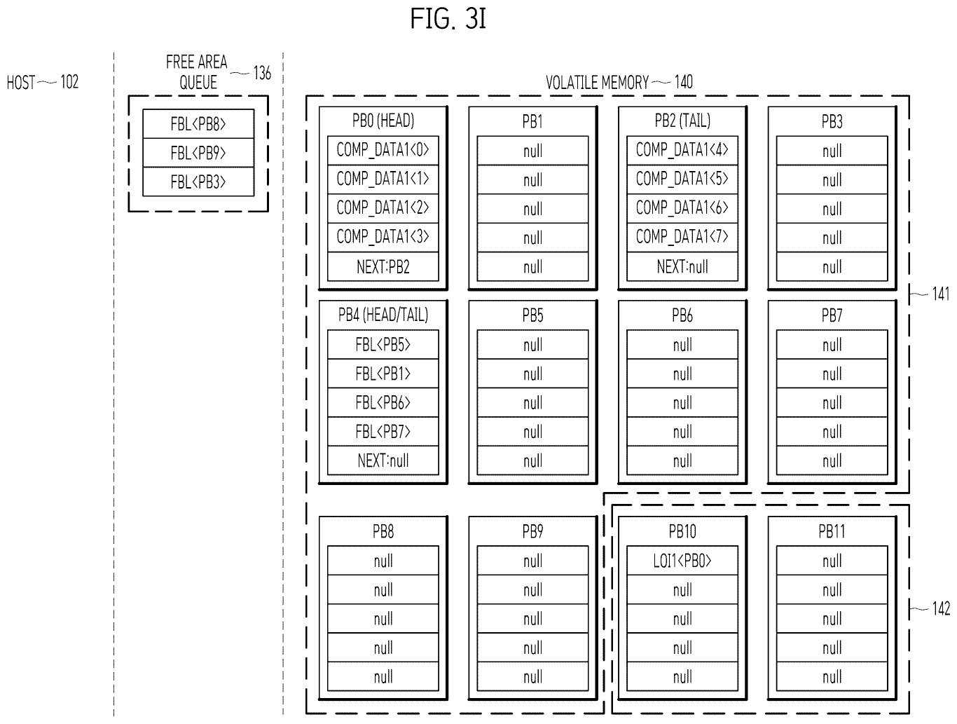

A first embodiment to be described below with reference to FIGS. 2A to 2H may be an embodiment corresponding to when the control operation component 134 controls the operation of the volatile memory 140 without using the free area queue 136. A second embodiment to be described with reference to FIGS. 3A to 3I may be an embodiment corresponding to when the control operation component 134 controls the operation of the volatile memory 140 while using the free area queue 136.

Specifically, the compression operation component 132 included in the controller 130 may generate compressed data by compressing write data. The write data may mean uncompressed original data, for example, raw data, and the compressed data may mean data obtained by compressing the write data through various compression algorithms such as LZ4, LZ4HC, and zStd.

The compression operation component 132 may vary a compression ratio depending on what value the write data has and what compression algorithm is used. According to an embodiment, the compression operation component 132 may generate first compressed data by compressing first write data at a first rate, and generate second compressed data by compressing second write data at a second rate higher than the first rate. In such a case, the first write data and the second write data may be data each having a set size. Accordingly, the size of the first compressed data compressed at the relatively low first rate may be larger than the size of the second compressed data compressed at the relatively high second rate.

The present disclosure describes generating two types of compressed data by compressing the write data at two types of ratios; however, this is merely an embodiment and actually, more types of compressed data may be generated by compressing the write data at more types of ratios.

The control operation component 134 included in the controller 130 may divide (i.e., set) the plurality of physical areas PB<0:11> included in the volatile memory 140 into a plurality of first physical areas 141 (PB<0:9>) and a plurality of second physical areas 142 (PB<10:11>).

According to an embodiment, the control operation component 134 may divide 10 physical areas PB<0:9> among 12 physical areas PB<0:11> into the first physical areas 141, and divide the remaining two physical areas PB<10:11> into the second physical areas 142, the 12 physical areas PB.<0:11> being included in the volatile memory 140 as illustrated in the drawing.

The present disclosure describes that the volatile memory 140 includes 12 physical areas; however, this is merely an embodiment and actually, the volatile memory 140 may include a larger number of physical areas. Likewise, the present disclosure describes which among the 12 physical areas included in the volatile memory 140, 10 physical areas corresponding to ⅚ of the 12 physical areas are divided into first physical areas and the remaining two physical areas corresponding to ⅙ of the 12 physical areas are divided into second physical areas; however, this is merely an embodiment and actually, the plurality of physical areas included in the volatile memory 140 may be divided into first and second physical areas by applying various ratios.

The control operation component 134 may store each of the first compressed data and the second compressed data compressed at different compression ratios in the first physical areas 141 without overlapping each other.

According to an embodiment, the control operation component 134 may store the first compressed data by setting the first number of physical areas among the first physical areas 141 as a first storage area (at least one of PB<0:9>) in order to manage the first number of physical areas in the form of a linked list. In addition, the control operation component 134 may store the second compressed data by setting the second number of physical areas among the first physical areas 141 as a second storage area (at least one of PB<0:9>) in order to manage the second number of physical areas in the form of a linked list. In such a case, the first number of physical areas set as the first storage areas and the second number of physical areas set as the second storage areas may be areas that do not overlap each other.

In addition, when two physical areas among the first physical areas 141 are set as the first storage areas, the control operation component 134 may set one of the two physical areas set as the first storage area as a header, set the other physical area as a tail, set next information of the header to point to the tail, and set a ‘null’ value indicating the absence of a next area in the next information of the tail.

In addition, when one physical area among the first physical areas 141 is set as the second storage area, the control operation component 134 may set the one physical area set as the second storage area as a header and a tail at the same time, and set a ‘null’ value indicating the absence of a next area in the next information.

Subsequently, the control operation component 134 may store each of first logical information, which indicates the first storage area among the first physical areas 141 where the first compressed data compressed at a first ratio is stored, and second logical information, which indicates the second storage area among the first physical areas 141 where the second compressed data compressed at a second ratio is stored, in the second physical areas 142 without overlapping each other. In particular, the control operation component 134 may set the first logical information to indicate a physical area set as a header, among the first number of physical areas included in the first storage areas. Similarly, the control operation component 134 may set the second logical information to indicate a physical area set as a header, among the second number of physical areas included in the second storage areas.

In this way, the control operation component 134 may set the first logical information to indicate only one physical area among the first number of physical areas, that is, a header area, by managing the first number of physical areas included in the first storage area in the form of a linked list. Similarly, the control operation component 134 may set the second logical information to indicate only one physical area among the second number of physical areas, that is, a header area, by managing the second number of physical areas included in the second storage area in the form of a linked list.

Accordingly, the control operation component 134 compresses a plurality of write data each having a set size at different N-types of ratios to generate a plurality of compressed data having different N-types of sizes, but may set a plurality of logical information respectively indicating the plurality of compressed data to have the same size. Here, N may be a natural number of 2 or more. That is, the control operation component 134 compresses the plurality of write data each having a set size at a first ratio and a second ratio to generate first compressed data and second compressed data having different sizes, but may set the first logical information and the second logical information respectively indicating the first compressed data and the second compressed data to have the same size.

Each of the plurality of physical areas PB<0:11> included in the volatile memory 140 may include a plurality of storage spaces. For example, each of the plurality of physical areas PB<0:11> includes five storage spaces. The ‘storage space’ means a space where data or information having a set size may be stored. For example, data or information having a size of 16 bytes is stored in one storage space and data or information having a size of 80 bytes is stored in one physical area.

The above-mentioned example is for convenience of description, and actually, it is also possible to set each of the physical areas to include a smaller or larger number of storage spaces than five. Likewise, it is also possible to set one storage space to actually store data or information having a size smaller or larger than 16 bytes.

Specifically, the control operation component 134 may use some of the plurality of storage spaces included in each of the first number of physical areas set as the first storage areas to store the first compressed data compressed at the first ratio, and use the remainder to store information for managing the linked list of the first storage area. Similarly, the control operation component 134 may use some of the plurality of storage spaces included in each of the second number of physical areas set as the second storage areas to store the second compressed data compressed at the second ratio, and use the remainder to store information for managing the linked list of the second storage area. The information for managing the linked list may mean next information being information indicating a next physical area according to the linked list.

According to an embodiment, the first compressed data compressed at the first ratio may have a size corresponding to eight storage spaces. Accordingly, the control operation component 134 may set two physical areas among the first physical areas 141 as the first storage areas in order to store the first compressed data compressed at the first ratio in the form of a linked list, store the first compressed data in eight storage spaces among 10 storage spaces included in the two physical areas, and store information for managing the linked list of the first storage areas in the remaining two storage spaces.

According to another embodiment, the second compressed data compressed at the second ratio may have a size corresponding to four storage spaces. Accordingly, the control operation component 134 may set one physical area among the first physical areas 141 as the second storage area in order to store the second compressed data compressed at the second ratio, store the second compressed data in four storage spaces among five storage spaces included in the one physical area, and store information for managing the linked list of the second storage area in the remaining one storage space.

Subsequently, the control operation component 134 may store one logical information in each of the plurality of storage spaces included in the second physical areas 142.

According to an embodiment, the control operation component 134 may store one of the first and second logical information in each of the plurality of storage spaces included in the second physical areas 142.

According to another embodiment, whenever the first compressed data compressed at the first ratio is stored in the first storage area in the form of a linked list to generate the first logical information, the control operation component 134 may search for an empty space among the plurality of storage spaces included in the second physical areas 142 and store the first logical information in the searched empty space. In addition, whenever the second compressed data compressed at the second ratio is stored in the second storage area in the form of a linked list to generate the second logical information, the control operation component 134 may search for an empty space among the plurality of storage spaces included in the second physical areas 142 and store the second logical information in the searched empty space. Accordingly, whenever generating a plurality of compressed data, that is, the first and second compressed data to generate a plurality of logical information, that is, the first and second logical information, the control operation component 134 may search for empty spaces among the plurality of storage spaces included in the second physical areas 142 and store the plurality of logical information, that is, the first and second logical information in the searched empty spaces, respectively. That is, the control operation component 134 may not distinguish an area for storing the first logical information and an area for storing the second logical information from each other in the second physical areas 142, and store the first logical information and the second logical information in the second physical areas 142 in the order in which the first logical information and the second logical information are generated.

In such a case, when reading the compressed data stored in the volatile memory 140, the control operation component 134 may sequentially check the logical information stored in each of the plurality of storage spaces included in the second physical areas 142, and search for a storage area where read-requested compressed data is stored, that is, a storage area where the read-requested compressed data is stored among the first physical areas 141. In addition, the control operation component 134 may sequentially read the compressed data stored in the searched storage area according to the linked list method.

According to another embodiment, the control operation component 134 may set, as a first selection area, at least one physical area among the plurality of physical areas divided into the second physical areas 142, and set the remaining physical areas as second selection areas. The control operation component 134 may store only the first logical information in each of the plurality of storage spaces included in the first selection area, and store only the second logical information in each of the plurality of storage spaces included in the second selection area. That is, when generating the first compressed data among the plurality of compressed data to generate the first logical information, the control operation component 134 may search for an empty space among the plurality of storage spaces included in the first selection area and store the first logical information in the searched empty space. In addition, when generating the second compressed data among the plurality of compressed data to generate the second logical information, the control operation component 134 may search for an empty space among the plurality of storage spaces included in the second selection area and store the second logical information in the searched empty space. That is, the control operation component 134 may divide a physical area where the first logical information is stored and a physical area where the second logical information is stored among the second physical areas 142 into the first selection area and the second selection area.

In such a case, when reading the compressed data stored in the volatile memory 140, the control operation component 134 may determine a selection area for searching for logical information based on the size of compressed data selected as a read target, that is, based on a ratio at which the compressed data has been compressed. That is, when the compressed data selected as the read target has a first size, the control operation component 134 may determine that a read request has occurred for the first compressed data compressed at the first ratio, and sequentially check the plurality of first logical information stored in each of the plurality of storage spaces included in the first selection area to search for the first storage area where the read-requested first compressed data is stored. In addition, when the compressed data selected as the read target has a second size smaller than the first size, the control operation component 134 may determine that a read request has occurred for the second compressed data compressed at the second ratio, and sequentially check the plurality of second logical information stored in each of the plurality of storage spaces included in the second selection area to search for the second storage area where the read-requested second compressed data is stored. In addition, the control operation component 134 may sequentially read the first or second compressed data stored in the searched first or second storage area, according to the linked list method.

Subsequently, the control operation component 134 may set some of the current number of free areas as management areas in order to store free area information on a free area capable of storing data among the first physical areas 141. In addition, the control operation component 134 may check the current number of free areas among the first physical areas 141, and vary the number of areas to be set as management areas among the current number of the free areas according to the checked current number of free areas. Accordingly, the control operation component 134 may use a variable number of free areas among the current number of free areas in order to store the free area information, and set the remaining number of free areas, excluding the variable number of free areas among the current number of free areas, as the first or second storage areas and use the first or second storage areas in order to store the first or second compressed data.

According to an embodiment, all 10 physical areas PB<0:9> divided into the first physical areas 141 may be free areas. In such a case, the control operation component 134 may set two of the 10 free areas as management areas, and store free area information on the remaining eight free areas in the two physical areas set as the management areas.

According to another embodiment, the first or second compressed data is stored in five physical areas set as the first or second storage areas among the 10 physical areas PB<0:9> divided into the first physical areas 141 and only five physical areas are free areas. In such a case, the control operation component 134 may set one of the five free areas as a management area and then store free area information on the four free areas in the one physical area included in the management area.

Subsequently, the control operation component 134 may manage some of the physical areas, which are set as management areas among the first physical areas 141, in the form of a linked list.

According to an embodiment, when two physical areas among the first physical areas 141 are set as management areas, the control operation component 134 may set one of the two physical areas set as the management areas as a header, set the other physical area as a tail, set next information of the header to point to the tail, and set a ‘null’ value indicating the absence of a next area in the next information of the tail.

According to another embodiment, when one physical area among the first physical areas 141 is set as a management area, the control operation component 134 may set the one physical area set as the management area as a header/a tail at the same time and set a ‘null’ value indicating the absence of a next area in the next information.

FIGS. 2A to 2H are diagrams for describing an operation of the storage device in accordance with the first embodiment of the present disclosure, which stores compressed data in a volatile memory and manages the stored compressed data.

Referring to FIGS. 2A to 2H, the operation of the control operation component 134 that stores and manages compressed data in the volatile memory 140 without using the free area queue 136 may be described.

It can be seen that FIGS. 2A to 2H illustrate only the volatile memory 140 and the host 102 included in the storage device 110 among the components of the data processing system illustrated in FIGS. 1A to 1C. That is, it can be seen that the operation of the storage device 110 to be described below with reference to FIGS. 2A to 2H is based on the configuration of the storage device 110 described with reference to FIGS. 1A to 1C.

In FIGS. 2A to 2H, the volatile memory 140 includes 12 physical areas PB<0:11>, and 10 PB<0:9> of the 12 physical areas PB<0:11> are divided into the first physical areas 141 and the remaining two PB<10:11> are divided into the second physical areas 142. Each of the 12 physical areas PB<0:11> included in the volatile memory 140 includes five storage spaces. This is merely an example for convenience of description, and actually, a different number of physical areas and storage spaces may be set.

Referring to FIG. 2A, an initialization state of the storage device 110 can be seen. The initialization state of the storage device 110 may mean a state in which no compressed data is stored in the volatile memory 140.

Specifically, in the initialization state, the control operation component 134 included in the controller 130 may divide the plurality of physical areas PB<0:11> included in the volatile memory 140 into the first physical areas 141 and the second physical areas 142.

Subsequently, the control operation component 134 may check the current number of free areas included in the first physical areas 141. In such a case, at a time prior to the state illustrated in the drawing, that is, before the two physical areas PB<0:1> are set as management areas, all 10 physical areas PB<0:9> included in the first physical areas 141 may have been free areas. Accordingly, the control operation component 134 may check that the current number of free areas among the first physical areas 141 is 10 by sequentially checking whether each of the 10 physical areas PB<0:9> divided into the first physical areas 141 is a free area.

In addition, the control operation component 134 may set, as management areas, some of the current number of free areas checked among the first physical areas 141.

According to an embodiment, as illustrated in the drawing, after checking that the number of free areas included in the first physical areas 141 is 10 (PB<0:9>) (checking that it exceeds 5 and 10 or less), the control operation component 134 may set, as management areas, the two areas PB<0:1> among the 10 current free areas PB<0:9> included in the first physical areas 141. In this way, the control operation component 134 may set the two physical areas PB<0:1> as management areas, generate free area information FBL<PB2:9> indicating that the remaining eight physical areas PB<2:9> are free areas, and store the generated free area information FBL<PB2:9> in the two physical area PB<0:1> set as the management areas.

In such a case, the control operation component 134 may manage the two physical areas PB<0:1> set as the management areas, in the form of a linked list. That is, the control operation component 134 may manage the two physical areas PB<0:1> in the form of a linked list by setting a first management area PB0, which is one of the two physical area PB<0:1> set as the management areas, as a header HEAD and setting a second management area PB1, which is the other one of the two physical area PB<0:1>, as a tail TAIL.

In addition, the control operation component 134 may store the free area information FBL<PB2:9> in four storage spaces among five storage spaces included in each of the two physical areas PB<0:1> set as the management areas, that is, a total of eight storage spaces. In addition, the control operation component 134 may store information NEXT for managing the linked list in one storage space among five storage spaces included in each of the two physical areas PB<0:1> set as the management areas, that is, a total of two storage spaces.

Specifically, the control operation component 134 may divide eight pieces of partial information FBL<PB2>, FBL<PB3>, FBL<PB4>, FBL<PB5>, FBL<PB6>, FBL<PB7>, FBL<PB8>, and FBL<PB9> included in the free area information FBL<PB2:9> into four pieces of partial information FBL<PB2:5> and four pieces of partial information FBL<PB6:9>, and store the four pieces of partial information FBL<PB2:5> and the four pieces of partial information FBL<PB6:9> in the two physical areas PB<0:1> set as the management areas, respectively.

In addition, the control operation component 134 may set the second management area PB1 in next information NEXT of the first management area PB0 set as the header HEAD out of the two physical areas PB<0:1> set as the management areas, and set a ‘null’ value indicating the absence of a next area in next information NEXT of the second management area PB1 being the tail TAIL.

According to another embodiment, unlike the drawing, the control operation component 134 may check that the first physical areas 141 include 15 free areas (check that it exceeds 10 and 15 or less). In such a case, the control operation component 134 may set three areas among the 15 current free areas included in the first physical areas 141 as management areas. In this way, the control operation component 134 may set three physical areas as management areas, generate free area information indicating that the remaining 12 physical areas are free areas, and store the generated free area information in the three physical areas set as the management areas.

In such a case, the control operation component 134 may manage the three physical areas set as the management areas, in the form of a linked list. That is, among the three physical areas set as the management areas, the control operation component 134 may set one physical area as s header, set another one physical area as a tail, and set the remaining one physical area as a middle between the header and the tail.

In addition, the control operation component 134 may store the free area information in four storage spaces among five storage spaces included in each of the three physical areas set as the management areas, that is, a total of 12 storage spaces. In addition, the control operation component 134 may store information NEXT for managing the linked list in one storage space among the five storage spaces included in each of the three physical areas set as the management areas, that is, a total of three storage spaces.

Specifically, the control operation component 134 may divide 12 pieces of partial information included in the free area information into four pieces of partial information, four pieces of partial information, and four pieces of partial information, and store the divided partial information in the three physical areas set as the management areas, respectively.

In addition, the control operation component 134 may set the management area set as the middle in the next information of the management area set as the header, among the three physical areas set as the management areas, set the management area set as the tail in the next information of the management area set as the middle, and set a ‘null’ value indicating the absence of a next area in the next information of the management area set as the tail.

In FIG. 2A, since no compressed data is stored in the first physical areas 141, the control operation component 134 may not store any logical data in the second physical areas 142.

Referring to FIG. 2B, it can be seen how the storage device 110 manages first write data NM_DATA1 generated in the host 102 after the initialization state of the storage device 110 set in FIG. 2A.

Specifically, the compression operation component 132 included in the controller 130 may generate first first-compressed data COMP_DATA1<0:7> by compressing the first write data NM_DATA1 transmitted from the host 102 at the first ratio.

Subsequently, the control operation component 134 included in the controller 130 may refer to the free area information stored in the management area in order to store the first first-compressed data COMP_DATA1<0:7> in the volatile memory 140, and set two areas PB<2:3> of the eight free areas PB<2:9> included in the first physical areas 141 as first first-storage areas. That is, the control operation component 134 may check that the first first-compressed data COMP_DATA1<0:7> includes 8 partial data (check that it exceeds 4 and 8 or less), and then set the two areas PB<2:3> among the current free areas PB<2:9> of the first physical areas 141 as the first first-storage areas.

In addition, the control operation component 134 may manage the two physical areas PB<2:3> set as the first first-storage area in the form of a linked list. That is, out of the two physical areas PB<2:3> set as the first first-storage areas, the control operation component 134 may set a first area PB2 as a header HEAD, set a second area PB3 as a tail TAIL, and manage the first area PB2 and the second area PB3 in the form of a linked list.

In addition, the control operation component 134 may store the first first-compressed data COMP_DATA1<0:7> in four storage spaces among five storage spaces included in each of the two physical areas PB<2:3> set as the first first-storage areas, that is, a total of eight storage spaces. In addition, the control operation component 134 may store information NEXT for managing the linked list in one storage space among the five storage spaces included in each of the two physical areas PB<2:3> set as the first first-storage areas, that is, a total of two storage spaces.

Specifically, the control operation component 134 may divide eight pieces of partial data COMP_DATA1<0>, COMP_DATA1<1>, COMP_DATA1<2>, COMP_DATA1<3>, COMP_DATA1<4>, COMP_DATA1<5>, COMP_DATA1<6>, and COMP_DATA1<7> included in the first first-compressed data COMP_DATA1<0:7> into four pieces of partial data COMP_DATA1<0:3> and four pieces of partial data COMP_DATA1<4:7>, and store the four pieces of partial data COMP_DATA1<0:3> and the four pieces of partial data COMP_DATA1<4:7> in the two areas PB<2:3> set as the first first-storage areas, respectively.

In addition, the control operation component 134 may set the second area PB3 in next information NEXT of the first area PB2 set as the header HEAD out of the two physical areas PB<2:3> set as the first first-storage areas, and set a ‘null’ value indicating the absence of a next area in next information NEXT of the second area PB3 set as the tail TAIL.

Subsequently, the control operation component 134 may invalidate, in the management area, the information FBL<PB2:3> corresponding to the first first-storage area among the free area information after the storing first first-compressed data COMP_DATA1<0:7> in the first first-storage area. That is, the control operation component 134 may invalidate the information FBL<PB2:3> corresponding to the first first-storage areas and stored in two of the eight storage spaces set in the two physical areas PB<0:1>, which have been set as the management areas, in order to store the free area information. According to an embodiment, the operation of invalidating information stored in the storage space may be an operation of overwriting the value of the storage space with a specific value, for example, a ‘null’ value. According to another embodiment, the operation of invalidating information stored in the storage space may be an operation of indicating that the value of the storage space is invalidated so that other data or information may be set to be overwritten later.

In addition, the control operation component 134 may generate first first-logical information LOI1<PB2> indicating the first area PB2 set as the header HEAD out of the two areas PB<2:3> set as the first first-storage areas, and store the first first-logical information LOI1<PB2> in the second physical areas 142.

According to an embodiment, the control operation component 134 may store the first first-logical information LOI1<PB2> in an empty space (first space of PB10) among the five storage spaces included in each of the two areas PB<10:11> divided into second physical areas 142, that is, the 10 storage spaces.

According to another embodiment, the control operation component 134 may set a first area PB10 of the two areas PB<10:11> divided into the second physical areas 142 as a first selection area for storing first logical information LOI1<PBx>, and set a second area PB11 as a second selection area for storing second logical information LOI2<PBx>. Accordingly, the control operation component 134 may store the first first-logical information LOI1<PB2> in the empty space (first space of PB10) among the five storage areas included in the first area PB10 set as the first selection area.

Referring to FIG. 2C, it can be seen how second write data NM_DATA2 generated in the host 102 is managed in the storage device 110 after the first write data NM_DATA1 generated in the host 102 in FIG. 2B is stored in the first first-storage areas PB<2:3> of the volatile memory 140 as the first first-compressed data COMP_DATA1<0:7> compressed at the first ratio.

Specifically, the compression operation component 132 included in the controller 130 may generate first second-compressed data COMP_DATA2<0:3> by compressing the second write data NM_DATA2 transmitted from the host 102 at a second ratio. In such a case, as can be seen from the fact that the first first-compressed data COMP_DATA1<0:7> obtained by compressing the first write data NM_DATA1 at the first ratio includes 8 partial data and the first second-compressed data COMP_DATA2<0:3> obtained by compressing the second write data NM_DATA2 at the second ratio includes four partial data, it can be seen that the compression rate of the second ratio is higher than that of the first ratio.

Subsequently, in order to store the first second-compressed data COMP_DATA2<0:3> in the volatile memory 140, the control operation component 134 included in the controller 130 may refer to valid information FBL<PB4:9> of the free area information stored in the two physical areas PB<0:1> set as the management areas, and set one area PB4 of the six free areas PB<4:9> included in the first physical areas 141 as a first second-storage area. That is, the control operation component 134 may check that the first second-compressed data COMP_DATA2<0:3> includes four partial data (check that it is 4 or less), and then set the one area PB4 of the current free areas PB<4:9> of the first physical areas 141 as the first second-storage area.

In addition, the control operation component 134 may manage the one physical area PB4 set as the first second-storage area in the form of a linked list. That is, the one physical area PB4 set as the first second-storage area may be set as a header HEAD and a tail TAIL at the same time and managed in the form of the linked list.

In addition, the control operation component 134 may store the first second-compressed data COMP_DATA2<0:3> in four of the five storage spaces included in the one physical area PB4 set as the first second-storage area. In addition, the control operation component 134 may store information NEXT for managing the linked list in one of the five storage spaces included in the one physical area PB4 set as the first second-storage area.

Specifically, the control operation component 134 may store the four partial data COMP_DATA2<0>, COMP_DATA2<1>, COMP_DATA2<2>, and COMP_DATA2<3> included in the first second-compressed data COMP_DATA2<0:3>, in the one area PB4 set as the first second-storage area.

In addition, the control operation component 134 may set a ‘null’ value indicating the absence of a next area in next information NEXT of the one physical area PB4 set as the header HEAD and the tail TAIL at the same time in the first second-storage area.

In addition, the control operation component 134 may store the first second-compressed data COMP_DATA2<0:3> in the first second-storage area, and then invalidate, in the management area, the information FBL<PB4> corresponding to the first second-storage area among the free area information. That is, the control operation component 134 may invalidate the information FBL<PB4> corresponding to the first second-storage storage area and stored in one of the eight storage spaces set in the two physical areas PB<0:1>, which have been set as the management areas, in order to store the free area information.

In addition, the control operation component 134 may generate first second-logical information LOI2<PB4> indicating the area PB4 set as the header HEAD of the one area PB<4> set as the first first-storage area, and store the first second-logical information LOI2<PB4> in the second physical areas 142.

According to an embodiment, the control operation component 134 may store the first second-logical information LOI2<PB4> in an empty space (second space of PB10) among the five storage spaces included in each of the two areas PB<10:11> divided into second physical areas 142, that is, the 10 storage spaces.

According to another embodiment, the control operation component 134 may set the first area PB10 of the two areas PB<10:11> divided into the second physical areas 142 as a first selection area for storing the first logical information LOI1<PBx>, and set the second area PB11 as a second selection area for storing the second logical information LOI2<PBx>. Accordingly, the control operation component 134 may store the first second-logical information LOI2<PB4> in the empty space (first space of PB11) among the five storage areas included in the second area PB11 set as the second selection area unlike the drawing.

Referring to FIG. 2D, it can be seen how third write data NM_DATA3 generated in the host 102 is managed in the storage device 110 after the second write data NM_DATA2 generated in the host 102 in FIG. 2C is stored in the second storage area PB<4> of the volatile memory 140 as the first second-compressed data COMP_DATA2<0:3> compressed at the second ratio.

Specifically, the compression operation component 132 included in the controller 130 may generate second second-compressed data COMP_DATA3<0:3> by compressing the third write data NM_DATA3 transmitted from the host 102 at a second ratio. In such a case, as can be seen from the fact that the first first-compressed data COMP_DATA1<0:7> obtained by compressing the first write data NM_DATA1 at the first ratio includes 8 partial data, the first second-compressed data COMP_DATA2<0:3> obtained by compressing the second write data NM_DATA2 at the second ratio includes four partial data, and the second second-compressed data COMP_DATA3<0:3> obtained by compressing the third write data NM_DATA3 at the second ratio includes four partial data, it can be seen that the compression rate of the second ratio is higher than that of the first ratio.

Subsequently, in order to store the second second-compressed data COMP_DATA3<0:3> in the volatile memory 140, the control operation component 134 included in the controller 130 may refer to valid information FBL<PB5:9> of the free area information stored in the two physical areas PB<0:1> set as the management areas, and set one area PB5 of the five free areas PB<5:9> included in the first physical areas 141 as a second second-storage area. That is, the control operation component 134 may check that the second second-compressed data COMP_DATA3<0:3> includes four partial data (check that it is 4 or less), and then set the one area PB5 of the current free areas PB<5:9> of the first physical areas 141 as the second second-storage area.

In addition, the control operation component 134 may manage the one physical area PB5 set as the second second-storage area in the form of a linked list. That is, the one physical area PB5 set as the second second-storage area may be set as a header HEAD and a tail TAIL at the same time and managed in the form of the linked list.

In addition, the control operation component 134 may store the second second-compressed data COMP_DATA3<0:3> in four of the five storage spaces included in the one physical area PB5 set as the second second-storage area. In addition, the control operation component 134 may store information NEXT for managing the linked list in one of the five storage spaces included in the one physical area PB5 set as the second second-storage area.

Specifically, the control operation component 134 may store the four partial data COMP_DATA3<0>, COMP_DATA3<1>, COMP_DATA3<2>, and COMP_DATA3<3> included in the second second-compressed data COMP_DATA3<0:3>, in the one physical area PB5 set as the second second-storage area.

In addition, the control operation component 134 may set a ‘null’ value indicating the absence of a next area in next information NEXT of the one physical area PB5 set as the header HEAD and tail TAIL at the same time in the second second-storage area.

In addition, the control operation component 134 may store the second second-compressed data COMP_DATA3<0:3> in the second second-storage area, and then invalidate, in the management area, the information FBL<PB5> corresponding to the second second-storage area among the free area information. That is, the control operation component 134 may invalidate the information FBL<PB5> corresponding to the second second-storage storage area and stored in one of the eight storage spaces set in the two physical areas PB<0:1>, which have been set as the management areas, in order to store the free area information. In such a case, the information FBL<PB2:3> corresponding to the first first-storage area among the eight storage spaces set in order to store the free area information in the two physical areas PB<0:1> set as the management areas has already been invalidated in FIG. 2B and the information FBL<PB4> corresponding to the first second-storage area has already been invalidated in FIG. 2C. Accordingly, in FIG. 2D, the information FBL<PB2:5> corresponding to the first first-storage area, the first second-storage area, and the second second-storage area may all be invalidated, the information FBL<PB2:5> being stored in four of the eight storage spaces set in the two physical areas PB<0:1>, which have been set as the management areas, in order to store the free area information.

In addition, the control operation component 134 may generate second second-logical information LOI2<PB5> indicating the area PB5 set as the header HEAD of the one area PB<5> set as the second second-storage area, and store the second second-logical information LOI2<PB5> in the second physical areas 142.

According to an embodiment, the control operation component 134 may store the second second-logical information LOI2<PB5> in an empty space (third space of PB10) among the five storage spaces included in each of the two areas PB<10:11> divided into second physical areas 142, that is, the 10 storage spaces.

According to another embodiment, the control operation component 134 may set the first area PB10 of the two areas PB<10:11> divided into the second physical areas 142 as a first selection area for storing the first logical information LOI1<PBx>, and set the second area PB11 as a second selection area for storing the second logical information LOI2<PBx>. Accordingly, the control operation component 134 may store the second second-logical information LOI2<PB5> in an empty space (second space of PB11) among the five storage areas included in the second area PB11 set as the second selection area unlike the drawing.

Referring to FIGS. 2E and 2F, it can be seen how the area PB0 where the invalidated information FBL<PB2:5> among the free area information has been stored is managed in the two physical areas PB<0:1> set as the management areas after the first first-compressed data COMP_DATA1<0:7>, the first second-compressed data COMP_DATA2<0:3>, and the second second-compressed data COMP_DATA3<0:3> are stored in the first first-storage areas PB<2:3>, the first second-storage area PB<4>, and the second second-storage area PB<5> of the volatile memory 140 in FIGS. 2B to 2D.

First, referring to FIG. 2E, after the first first-compressed data COMP_DATA1<0:7>, the first second-compressed data COMP_DATA2<0:3>, and the second second-compressed data COMP_DATA3<0:3> are stored in the first first-storage areas PB<2:3>, the first second-storage area PB<4>, and the second second-storage area PB<5> of the volatile memory 140, the information FBL<PB2:5> corresponding to the first first-storage areas PB<2:3>, the first second-storage area PB<4>, and the second second-storage area PB<5> may be invalidated in the management area and may not be managed in the free area information. This may mean that the four pieces of information FBL<PB2:5> stored in the first management area PB0 set as the header HEAD of the two physical areas PB<0:1> set as the management areas are all invalidated.

In such a case, the control operation component 134 may set, as a new header HEAD, the second management area PB1 set in the next information NEXT of the first management area PB0 set as the header HEAD, that is, the physical area PB1 set as the tail TAIL in the drawing. In this way, while setting the second management area PB1, which has already been set as the tail TAIL, as the header HEAD, the second management area PB1 may be set as the header HEAD and the tail TAIL at the same time.

In addition, the control operation component 134 may invalidate the next information NEXT of the first management area PB0 while setting the second management area PB1 as the header HEAD and tail TAIL at the same time. That is, the control operation component 134 may invalidate all data or information stored in the five storage areas included in the first management area PB0.

Referring to FIG. 2F, after invalidating all data or information stored in the five storage areas included in the first management area PB0, the control operation component 134 may switch the first management area PB0 into a free area and put the free area into the free area information.

Specifically, after switching the first management area PB0 into the free area, the control operation component 134 may check whether information FBL<PB0> corresponding to the free area may be stored in the management area and put into the free area information, that is, the information FBL<PB0> may be stored in the second management area PB1 set as the header HEAD and tail TAIL at the same time.

As illustrated in the drawing, when there is no remaining storage space in the second management area PB1, the control operation component 134 may check that the information FBL<PB0> corresponding to the new free area PB0 is not storable in the second management area PB1. Accordingly, the control operation component 134 may put one free area PB6 into the management area as a third management area with reference to the free area information stored in the second management area PB1, and manage the second management area PB1 previously included and the third management area PB6 in the form of a linked list. That is, the control operation component 134 may store the information FBL<PB0> corresponding to the new free area PB0 in the third management area PB6 newly included in the management area, put the information FBL<PB0> into the free area information, set the third management area PB6 in the next information NEXT of the second management area PB1, and then set a ‘null’ value indicating the absence of a next area in the next information NEXT of the third management area PB6. Through this, the control operation component 134 may set the second management area PB1, which has been set as the header HEAD and the tail TAIL at the same time, as only a header HEAD, and set the newly added third management area PB6 as a tail TAIL.

In addition, the control operation component 134 may invalidate information FBL<PB6> corresponding to the third management area PB6 newly included in the management area among the free area information stored in the second management area PB1. That is, the control operation component 134 may invalidate one piece of information FBL<PB6> among the free area information stored in the second management area PB1, newly switch the second management area PB1 to a free area, store generated information FBL<PB0> in the third management area PB6 newly included in the management area, and put the information FBL<PB0> into the free area information.

Unlike the drawing, when there is a remaining storage space in the second management area PB1, the control operation component 134 may store the information FBL<PB0> corresponding to the new free area PB0 in the remaining storage space of the second management area PB1, put the information FBL<PB0> into the free area information. That is, the second management area PB1 may continuously maintain the state set as the header HEAD and the tail TAIL.

Since in the drawing the management area includes the two physical areas PB<0:1>, when the first management area PB0 set as the header HEAD is invalidated, the second management area PB1 may be set as the header HEAD and the tail TAIL at the same time.

According to an embodiment, unlike the drawing, when the management area includes three or more physical areas, a physical area set as the header and a physical area set as the tail may be divided into different areas even when the physical area set as the header is invalidated. According to another embodiment, unlike the drawing, in a case where the management area includes only one physical area set as the header HEAD and the tail TAIL at the same time, when the physical area is invalidated, one remaining physical area may be switched into a free area by releasing the management area and not managing the free area information.

Referring to FIG. 2G, it can be seen how the control operation component 134 operates in response to a command requesting invalidation of the first first-logical information LOI1<PB2> after the state described with reference to FIG. 2F.

Specifically, the state described with reference to FIG. 2F may mean a state in which the first first-compressed data COMP_DATA1<0:7> is stored in the first first-storage areas PB<2:3> of the volatile memory 140, the first first-logical information LOI1<PB2> is stored in the first space (first space of PB10) among the ten storage spaces included in the second physical areas 142, and the management area includes two physical areas PB<1, 6>.

In such a state, in order to invalidate the first first-compressed data COMP_DATA1<0:7> stored in the volatile memory 140, the host 102 may generate the command requesting the invalidation of the first first-logical information LOI1<PB2>, and transmit the generated command to the control operation component 134 of the controller 130. In response to the command requesting the invalidation of the first first-logical information LOI1<PB2>, the control operation component 134 may invalidate the first first-logical information LOI1<PB2> stored in the first space (first space of PB10) of the second physical areas 142.

In such a case, since the control operation component 134 performs a read operation on the first first-compressed data COMP_DATA1<0:7> through the first first-logical information LOI1<PB2>, the first first-logical information LOI1<PB2> stored in the first space (first space of PB10) of the second physical areas 142 is invalidated, so that the first first-compressed data COMP_DATA1<0:7> stored in the two physical areas PB<2:3> set as the first storage areas indicated by the first first-logical information LOI1<PB2> may also be invalidated.

In addition, the control operation component 134 may invalidate the first space (first space of PB10) of the second physical areas 142 and the first first-storage areas PB<2:3> in response to the command requesting the invalidation of the first first-logical information LOI1<PB2>, switch the first first-storage areas PB<2:3> into free areas, store the information FBL<PB2:3> corresponding to the first first-storage areas PB<2:3> in the third management area PB6 set as the management area, and put the information FBL<PB2:3> into the free area information.

Referring to FIG. 2H, it can be seen how the control operation component 134 operates in response to a command requesting invalidation of the first second-logical information LOI2<PB4> after the state described with reference to FIG. 2F.

Specifically, the state described with reference to FIG. 2F may mean a state in which the first second-compressed data COMP_DATA2<0:3> is stored in the first second-storage area PB<4> of the volatile memory 140, the first second-logical information LOI2<PB4> is stored in a second space (second space of PB10) among the 10 storage spaces included in the second physical areas 142, and the management area includes the two physical areas PB<1, 6>.

In such a state, in order to invalidate the first second-compressed data COMP_DATA2<0:3> stored in the volatile memory 140, the host 102 may generate the command requesting the invalidation of the first second-logical information LOI2<PB4>, and transmit the generated command to the control operation component 134 of the controller 130. In response to the command requesting the invalidation of the first second-logical information LOI2<PB4>, the control operation component 134 may invalidate the first second-logical information LOI2<PB4> stored in the second space (second space of PB10) of the second physical areas 142.

In such a case, since the control operation component 134 performs a read operation on the first second-compressed data COMP_DATA2<0:3> through the first second-logical information LOI2<PB4>, the first second-logical information LOI2<PB4> stored in the second space (second space of PB10) of the second physical areas 142 is invalidated, so that the first second-compressed data COMP_DATA2<0:3> stored in the one physical area PB4 set as the second storage area indicated by the first second-logical information LOI2<PB4> may also be invalidated.

In addition, the control operation component 134 may invalidate the second space (second space of PB10) of the second physical areas 142 and the first second-storage area PB<4> in response to the command requesting the invalidation of the first second-logical information LOI2<PB4>, switch the first second-storage area PB<4> into a free area, store the information FBL<PB4> corresponding to the first second-storage area PB<4> in the third management area PB6 set as the management area, and put the information FBL<PB4> into the free area information.

FIGS. 3A to 3I are diagrams for describing an operation of the storage device in accordance with the second embodiment of the present disclosure, which stores compressed data in a volatile memory and manages the stored compressed data.

Referring to FIGS. 3A to 3I, an operation in which the control operation component 134 stores compressed data in the volatile memory 140 and manages the compressed data while using the free area queue 136 may be described. In such a case, the control operation component 134 may use the free area queue 136 in a state in which the free area queue 136 is stored in an allocated area of the internal memory 137. In particular, the internal memory 137 included in the control operation component 134 may be a memory with a relatively higher operating speed than the volatile memory 140. For example, when the volatile memory 140 is DRAM, the internal memory 137 included in the control operation component 134 may be SRAM.

It can be seen that FIGS. 3A to 3I illustrate only the volatile memory 140 and the host 102 included in the storage device 110 among the components of the data processing system illustrated in FIGS. 1A to 1C. That is, it can be seen that the operation of the storage device 110 to be described below with reference to FIGS. 3A to 3I is based on the configuration of the storage device 110 described with reference to FIGS. 1A to 1C.

In addition, in FIGS. 3A to 3I, the volatile memory 140 includes 12 physical areas PB<0:11>, and 10 PB<0:9> of the 12 physical areas PB<0:11> are divided into the first physical areas 141 and the remaining two PB<10:11> are divided into the second physical areas 142. In addition, each of the 12 physical areas PB<0:11> included in the volatile memory 140 includes five storage spaces. This is merely an example for convenience of description, and actually, a different number of physical areas and storage spaces may be set.

Referring to FIG. 3A, an initialization state of the storage device 110 can be seen. In such a case, the initialization state of the storage device 110 may mean a state in which no compressed data is stored in the volatile memory 140.

Specifically, in the initialization state, the control operation component 134 included in the controller 130 may divide the plurality of physical areas PB<0:11> included in the volatile memory 140 into the first physical areas 141 and the second physical areas 142.

Subsequently, the control operation component 134 may check the current number of free areas included in the first physical areas 141. In such a case, at a time prior to the state illustrated in the drawing, that is, before the two physical areas PB<0:1> are set as management areas, all ten physical areas PB<0:9> included in the first physical areas 141 may have been free areas. Accordingly, the control operation component 134 may check that the current number of free areas among the first physical areas 141 is 10 by sequentially checking whether each of the 10 physical areas PB<0:9> divided into the first physical areas 141 is a free area.

In addition, the control operation component 134 may set, as management areas, some of the current number of free areas checked among the first physical areas 141.

According to an embodiment, as illustrated in the drawing, after checking that the number of free areas included in the first physical areas 141 is 10 (PB<0:9>) (checking that it exceeds 5 and 10 or less), the control operation component 134 may set, as management areas, two areas PB<0:1> among the 10 current free areas PB<0:9> included in the first physical areas 141. In this way, the control operation component 134 may set the two physical areas PB<0:1> as management areas, generate free area information FBL<PB2:9> indicating that the remaining eight physical areas PB<2:9> are free areas, and store the generated free area information FBL<PB2:9> in the two physical area PB<0:1> set as the management areas.

In such a case, the control operation component 134 may manage the two physical areas PB<0:1> set as the management areas, in the form of a linked list. That is, the control operation component 134 may manage the two physical areas PB<0:1> in the form of a linked list by setting a first management area PB0, which is one of the two physical area PB<0:1> set as the management areas, as a header HEAD and setting a second management area PB1, which is the other one of the two physical area PB<0:1>, as a tail TAIL.

In addition, the control operation component 134 may store the free area information FBL<PB2:9> in four storage spaces among five storage spaces included in each of the two physical areas PB<0:1> set as the management areas, that is, a total of eight storage spaces. In addition, the control operation component 134 may store information NEXT for managing the linked list in one storage space among five storage spaces included in each of the two physical areas PB<0:1> set as the management areas, that is, a total of two storage spaces.

Specifically, the control operation component 134 may divide eight pieces of partial information FBL<PB2>, FBL<PB3>, FBL<PB4>, FBL<PB5>, FBL<PB6>, FBL<PB7>, FBL<PB8>, and FBL<PB9> included in the free area information FBL<PB2:9> into four pieces of partial information FBL<PB2:5> and four pieces of partial information FBL<PB6:9>, and store the four pieces of partial information FBL<PB2:5> and the four pieces of partial information FBL<PB6:9> in the two physical areas PB<0:1> set as the management areas, respectively.

In addition, the control operation component 134 may set the second management area PB1 in next information NEXT of the first management area PB0 set as the header HEAD out of the two physical areas PB<0:1> set as the management areas, and set a ‘null’ value indicating the absence of a next area in next information NEXT of the second management area PB1 being the tail TAIL.

According to another embodiment, unlike the drawing, the control operation component 134 may check that the first physical areas 141 include 15 free areas (check that it exceeds 10 and 15 or less). In such a case, the control operation component 134 may set three areas among the 15 current free areas included in the first physical areas 141 as management areas. In this way, the control operation component 134 may set three physical areas as management areas, generate free area information indicating that the remaining 12 physical areas are free areas, and store the generated free area information in the three physical areas set as the management areas.

In such a case, the control operation component 134 may manage the three physical areas set as the management areas, in the form of a linked list. That is, among the three physical areas set as the management areas, one physical area may be set as s header, another one physical area may be set as a tail, and the remaining one physical area may be set as a middle between the header and the tail.

In addition, the control operation component 134 may store the free area information in four storage spaces among five storage spaces included in each of the three physical areas set as the management areas, that is, a total of 12 storage spaces. In addition, the control operation component 134 may store information NEXT for managing the linked list in one storage space among the five storage spaces included in each of the three physical areas set as the management areas, that is, a total of three storage spaces.

Specifically, the control operation component 134 may divide 12 pieces of partial information included in the free area information into four pieces of partial information, four pieces of partial information, and four pieces of partial information, and store the divided partial information in the three physical areas set as the management areas, respectively.

In addition, the control operation component 134 may set the management area set as the middle in the next information of the management area set as the header, among the three physical areas set as the management areas, set the management area set as the tail in the next information of the management area set as the middle, and set a ‘null’ value indicating the absence of a next area in the next information of the management area set as the tail.

In FIG. 3A, since no compressed data is stored in the first physical areas 141, the control operation component 134 may not store any logical data in the second physical areas 142.

Referring to FIG. 3B, it can be seen that some of the free area information is moved to the free area queue 136 allocated to the internal memory 137 for management after the free area information is stored in the management area of the volatile memory 140 in FIG. 3A.

Specifically, the control operation component 134 may select partial information of the free area information managed in the management area of the volatile memory 140, and move the selected information to the free area queue 136 allocated to the internal memory 137.

In addition, the control operation component 134 may move the partial information of the free area information managed in the management area to the free area queue 136 allocated to the internal memory 137, switch a physical area having stored the partial information of the free area information, among the first physical areas 141 set as the management area into a free area, and move information on the switched free area to the free area queue 136 for management.

According to the embodiment, as illustrated in the drawing, the control operation component 134 may move the partial information FBL<PB2:5> of the free area information, which is stored in the first management area PB0 set as the header HEAD out of the two physical areas PB<0, 4> set as the management areas, to the free area queue 136 for management. In such a case, the control operation component 134 may set, as a new header HEAD, the second management area PB1 set in the next information NEXT of the first management area PB0 set as the header HEAD in the management area, that is, the physical area PB1 set as the tail TAIL in the drawing. In this way, while setting the second management area PB1, which has already been set as the tail TAIL, as the header HEAD, the second management area PB1 may be set as the header HEAD and the tail TAIL at the same time. In addition, the control operation component 134 may move the partial information FBL<PB2:5> of the free area information stored in the first management area PB0 to the free area queue 136, switch the first management area PB0 into a free area, move information FBL<PB0> on the area PB0 switched into the free area to the free area queue 136, and then manage the information FBL<PB0> together with the partial information FBL<PB2:5>.

Referring to FIG. 3C, it can be seen how the storage device 110 manages first write data NM_DATA1 generated in the host 102 after the state described with reference to FIG. 3B.

Specifically, the compression operation component 132 included in the controller 130 may generate first first-compressed data COMP_DATA1<0:7> by compressing the first write data NM_DATA1 transmitted from the host 102 at a first ratio.

Subsequently, the control operation component 134 included in the controller 130 may refer to the free area queue 136 and the free area information managed in the management area in order to store the first first-compressed data COMP_DATA1<0:7> in the volatile memory 140, and set two areas PB<0, 2> of nine free areas PB<0, 2:9> included in the first physical areas 141 as first storage areas. That is, the control operation component 134 may check that the first first-compressed data COMP_DATA1<0:7> includes 8 partial data (check that it exceeds 4 and is 8 or less), and then set two areas PB<0, 2> among the current free areas PB<0, 2:9> of the first physical areas 141 as the first-first storage areas.

In addition, the control operation component 134 may manage the two physical areas PB<0, 2> set as the first first-storage areas, in the form of a linked list. That is, out of the two physical areas PB<0, 2> set as the first first-storage areas, the control operation component 134 may set a first area PB0 as a header HEAD, set a second area PB2 as a tail TAIL, and manage the first area PB0 and the second area PB2 in the form of a linked list.

In addition, the control operation component 134 may store the first first-compressed data COMP_DATA1<0:7> in four storage spaces among five storage spaces included in each of the two physical areas PB<0, 2> set as the first first-storage areas, that is, a total of eight storage spaces. In addition, the control operation component 134 may store information NEXT for managing the linked list in one storage space among the five storage spaces included in each of the two physical areas PB<0, 2> set as the first first-storage areas, that is, a total of two storage spaces.

Specifically, the control operation component 134 may divide eight pieces of partial data COMP_DATA1<0>, COMP_DATA1<1>, COMP_DATA1<2>, COMP_DATA1<3>, COMP_DATA1<4>, COMP_DATA1<5>, COMP_DATA1<6>, and COMP_DATA1<7> included in the first first-compressed data COMP_DATA1<0:7> into four pieces of partial data COMP_DATA1<0:3> and four pieces of partial data COMP_DATA1<4:7>, and store the four pieces of partial data COMP_DATA1<0:3> and the four pieces of partial data COMP_DATA1<4:7> in the two areas PB<0, 2> set as the first first-storage areas, respectively.

In addition, the control operation component 134 may set the second area PB2 in next information NEXT of the first area PB0 set as the header HEAD out of the two physical areas PB<0, 2> set as the first first-storage areas, and set a ‘null’ value indicating the absence of a next area in next information NEXT of the second area PB2 set as the tail TAIL.

Subsequently, the control operation component 134 may invalidate, in the free area queue 136 and the management area, the information FBL<PB0, PB2> corresponding to the first first-storage areas among the free area information after storing the first first-compressed data COMP_DATA1<0:7> in the first first-storage areas. That is, the control operation component 134 may invalidate the information FBL<PB0, PB2> corresponding to the first first-storage areas among the free area information managed in the free area queue 136 and the management area. According to an embodiment, when the information FBL<PB0, PB2> corresponding to the first first-storage areas is stored in the free area queue 136 as illustrated in the drawing, the information FBL<PB0, PB2> may be deleted from the free area queue 136 and invalidated. According to another embodiment, the operation of invalidating information stored in the storage space may be an operation of overwriting the value of the storage space with a specific value, for example, a ‘null’ value. According to another embodiment, the operation of invalidating information stored in the storage space may be an operation of indicating that the value of the storage space is invalidated so that other data or information may be set to be overwritten later.

In addition, the control operation component 134 may generate first first-logical information LOI1<PB0> indicating the first area PB0 set as the header HEAD out of the two areas PB<0, 2> set as the first first-storage areas, and store the first first-logical information LOI1<PB0> in the second physical areas 142.

According to an embodiment, the control operation component 134 may store the first first-logical information LOI1<PB0> in an empty space (first space of PB10) among the five storage spaces included in each of the two areas PB<10:11> divided into second physical areas 142, that is, the 10 storage spaces.

According to another embodiment, the control operation component 134 may set a first area PB10 of the two areas PB<10:11> divided into the second physical areas 142 as a first selection area for storing first logical information LOI1<PBx>, and set a second area PB11 as a second selection area for storing second logical information LOI2<PBx>. Accordingly, the control operation component 134 may store the first first-logical information LOI1<PB0> in an empty space (first space of PB10) among the five storage areas included in the first area PB10 set as the first selection area.

Referring to FIG. 3D, it can be seen how second write data NM_DATA2 generated in the host 102 is managed in the storage device 110 after the first write data NM_DATA1 generated in the host 102 in FIG. 3C is stored in the first first-storage areas PB<0, 2> of the volatile memory 140 as the first first-compressed data COMP_DATA1<0:7> compressed at the first ratio.

Specifically, the compression operation component 132 included in the controller 130 may generate first second-compressed data COMP_DATA2<0:3> by compressing the second write data NM_DATA2 transmitted from the host 102 at a second ratio. In such a case, as can be seen from the fact that the first first-compressed data COMP_DATA1<0:7> obtained by compressing the first write data NM_DATA1 at the first ratio includes 8 partial data and the first second-compressed data COMP_DATA2<0:3> obtained by compressing the second write data NM_DATA2 at the second ratio includes four partial data, it can be seen that the compression rate of the second ratio is higher than that of the first ratio.

Subsequently, in order to store the first second-compressed data COMP_DATA2<0:3> in the volatile memory 140, the control operation component 134 included in the controller 130 may refer to the free area information managed in the free area queue 136 and the management area, and set one area PB3 of the seven free areas PB<3:9> included in the first physical areas 141 as a first second-storage area. That is, the control operation component 134 may check that the first second-compressed data COMP_DATA2<0:3> includes four partial data (check that it is 4 or less), and then set the one area PB3 of the current free areas PB<3:9> of the first physical areas 141 as the first second-storage area.

In addition, the control operation component 134 may manage the one physical area PB3 set as the first second-storage area, in the form of a linked list. That is, the one physical area PB3 set as the first second-storage area may be set as a header HEAD and a tail TAIL at the same time and managed in the form of the linked list.

In addition, the control operation component 134 may store the first second-compressed data COMP_DATA2<0:3> in four of the five storage spaces included in the one physical area PB3 set as the first second-storage area. In addition, the control operation component 134 may store information NEXT for managing the linked list in one of the five storage spaces included in the one physical area PB3 set as the first second-storage area.

Specifically, the control operation component 134 may store the four partial data COMP_DATA2<0>, COMP_DATA2<1>, COMP_DATA2<2>, and COMP_DATA2<3> included in the first second-compressed data COMP_DATA2<0:3>, in the one area PB3 set as the first second-storage area.

In addition, the control operation component 134 may set a ‘null’ value indicating the absence of a next area in next information NEXT of the one physical area PB3 set as the header HEAD and tail TAIL at the same time in the first second-storage area.

In addition, the control operation component 134 may store the first second-compressed data COMP_DATA2<0:3> in the first second-storage area, and then invalidate, in the free area queue 136 and the management area, the information FBL<PB3> corresponding to the first second-storage area among the free area information. That is, the control operation component 134 may invalidate the information FBL<PB3> corresponding to the first second-storage storage area among the free area information managed in the free area queue 136 and the management area.

In such a case, the information FBL<PB0, PB2> corresponding to the first first-storage area among the free area information managed in the free area queue 136 and the management area has already been invalidated in FIG. 3C. Accordingly, in FIG. 3D, the information FBL<PB0, PB2, PB3> corresponding to the first first-storage area and the first second-storage area among the free area information managed in the free area queue 136 and the management area may all be invalidated. According to an embodiment, when the information FBL<PB0, PB2, PB3> corresponding to the first first-storage area and the first second-storage area is stored in the free area queue 136 as illustrated in the drawing, the information FBL<PB0, PB2, PB3> may be deleted from the free area queue 136 and invalidated.

In addition, the control operation component 134 may generate first second-logical information LOI2<PB3> indicating the area PB3 set as the header HEAD of the one area PB<3> set as the first second-storage area, and store the first second-logical information LOI2<PB3> in the second physical areas 142.

According to an embodiment, the control operation component 134 may store the first second-logical information LOI2<PB3> in an empty space (second space of PB10) among the five storage spaces included in each of the two areas PB<10:11> divided into second physical areas 142, that is, the 10 storage spaces.

According to another embodiment, the control operation component 134 may set the first area PB10 of the two areas PB<10:11> divided into the second physical areas 142 as a first selection area for storing the first logical information LOI1<PBx>, and set the second area PB11 as a second selection area for storing the second logical information LOI2<PBx>. Accordingly, the control operation component 134 may store the first second-logical information LOI2<PB3> in an empty space (first space of PB11) among the five storage areas included in the second area PB11 set as the second selection area unlike the drawing.

Referring to FIG. 3E, it can be seen that some of the free area information stored in the management area of the volatile memory 140 is moved to the free area queue 136 allocated to the internal memory 137 for management after the state described with reference to FIG. 3D.

Specifically, the control operation component 134 may select partial information of the free area information managed in the management area of the volatile memory 140, and move the selected information to the free area queue 136 allocated to the internal memory 137.

In addition, the control operation component 134 may move the partial information of the free area information managed in the management area to the free area queue 136 allocated to the internal memory 137, switch a physical area having stored the partial information of the free area information, among the first physical areas 141 set as the management area into a free area, and move information on the switched free area to the free area queue 136 for management.

According to an embodiment, as illustrated in the drawing, the control operation component 134 may move partial information FBL<PB6:9> of the free area information, which is stored in the second management area PB1 set as the management area, to the free area queue 136 for management. In such a case, the control operation component 134 may check that ‘null’ is set in the next information NEXT of the second management area PB1 set as the header HEAD and the tail TAIL at the same time in the management area, and release the management area from the volatile memory 140.

In addition, the control operation component 134 move the partial information FBL<PB6:9> of the free area information stored in the second management area PB1 to the free area queue 136, switch the second management area PB1 into a free area, move information FBL<PB1> on the area PB1 switched into the free area to the free area queue 136, and then manage the information FBL<PB1> together with the partial information FBL<PB6:9>.

Accordingly, the control operation component 134 may manage the information FBL<PB1, PB6:9> moved to the free area queue 136 in FIG. 3E as free area information together with the information FBL<PB4:5> remaining in the free area queue 136 before FIG. 3E.

Referring to FIG. 3F, it can be seen how the control operation component 134 operates in response to a command requesting invalidation of the first first-logical information LOI1<PB0> after the state described with reference to FIG. 3E.

Specifically, the state described with reference to FIG. 3E may mean a state in which the first first-compressed data COMP_DATA1<0:7> is stored in the first first-storage areas PB<0, 2> of the volatile memory 140, the first first-logical information LOI1<PB0:0> is stored in the first space (first space of PB10) among the ten storage spaces included in the second physical areas 142, the management area of the volatile memory 140 is released, and the free area information is stored in the free area queue 136.

In such a state, in order to invalidate the first first-compressed data COMP_DATA1<0:7> stored in the volatile memory 140, the host 102 may generate the command requesting the invalidation of the first first-logical information LOI1<PB0>, and transmit the generated command to the control operation component 134 of the controller 130. In response to the command requesting the invalidation of the first first-logical information LOI1<PB0>, the control operation component 134 may invalidate the first first-logical information LOI1<PB0> stored in the first space (first space of PB10) of the second physical areas 142.

In such a case, since the control operation component 134 performs a read operation on the first first-compressed data COMP_DATA1<0:7> through the first first-logical information LOI1<PB0>, the first first-logical information LOI1<PB0> stored in the first space (first space of PB10) of the second physical areas 142 is invalidated, so that the first first-compressed data COMP_DATA1<0:7> stored in the two physical areas PB<0, 2> set as the first storage areas indicated by the first first-logical information LOI1<PB0> may also be invalidated.

In addition, the control operation component 134 may invalidate the first space (first space of PB10) of the second physical areas 142 and the first first-storage areas PB<0, 2> in response to the command requesting the invalidation of the first first-logical information LOI1<PB0>, switch the first first-storage areas PB<0, 2> into free areas, store the information FBL<PB0, PB2> corresponding to the first first-storage areas PB<0, 2> in the free area queue 136, and put the information FBL<PB0, PB2> into the free area information.

Accordingly, in the free area queue 136, the information FBL<PB0, PB2> moved to the free area queue 136 in FIG. 3F may be managed as free area information, together with the information FBL<PB4:5, PB1, PB6:9> remaining in the free area queue 136 before FIG. 3F. In such a case, the information FBL<PB4:5, PB1, PB6:9> remaining in the free area queue 136 before FIG. 3F may be aligned to be referenced with a higher priority than the information FBL<PB0, PB2> moved to the free area queue 136 after FIG. 3F.

Referring to FIG. 3G, it can be seen that some of the free area information stored in the free area queue 136 is moved to the management area of the volatile memory 140 for management.

Specifically, the internal memory 137 included in the control operation component 134 may have a relatively small overall storage space instead of having a higher operating speed than the volatile memory 140. Accordingly, when the size of the free area queue 136 allocated to the internal memory 137 exceeds an appropriate size, the free area information stored in the free area queue 136 may be moved to the management area of the volatile memory 140 for management.

More specifically, all free area information may be stored in the free area queue 136 after FIG. 3F. In addition, in the volatile memory 140, the management area may be released.

In such a state, the control operation component 134 may set some of the first physical areas 141 of the volatile memory 140 as management areas, and then move some of the free area information stored in the free area queue 136 for management.

According to an embodiment, free area information on a total of nine free areas PB<4:5, 1, 6:9, 0:2> may be stored in the free area queue 136 after FIG. 3F. The control operation component 134 may refer to the free area information stored in the free area queue 136, and set, as a management area, the physical area PB4 of the volatile memory 140 corresponding to one piece of information FBL<PB4> among the nine pieces of information FBL<PB4:5, PB1, PB6:9, PB0, PB2>. In such a case, the one physical area PB4 set as the management area may be set as the header HEAD and the tail TAIL, and ‘null’ may be set in the next information NEXT.

Subsequently, the control operation component 134 may refer to the free area information stored in the free area queue 136, move four pieces of information FBL<PB5, PB1, PB6:7> of eight pieces of information FBL<PB5, PB1, PB6:9, PB0, PB2> to the one physical area PB4 set as the management area, store the four pieces of information FBL<PB5, PB1, PB6:7>, and manage only the remaining four pieces of information FBL<PB8:9, PB0, PB2> in the free area queue 136.

Referring to FIG. 3H, it can be seen how the control operation component 134 operates in response to a command requesting invalidation of the first second-logical information LOI2<PB3> after the state described with reference to FIG. 3E.

Specifically, the state described with reference to FIG. 3E may mean a state in which the first second-compressed data COMP_DATA2<0:3> is stored in the first second-storage area PB<3> of the volatile memory 140, the first second-logical information LOI2<PB3> is stored in the second space (second space of PB10) among the ten storage spaces included in the second physical areas 142, the management area of the volatile memory 140 is released, and the free area information is stored in the free area queue 136.

In such a state, in order to invalidate the first second-compressed data COMP_DATA2<0:3> stored in the volatile memory 140, the host 102 may generate the command requesting the invalidation of the first second-logical information LOI2<PB3>, and transmit the generated command to the control operation component 134 of the controller 130. In response to the command requesting the invalidation of the first second-logical information LOI2<PB3>, the control operation component 134 may invalidate the first second-logical information LOI2<PB3> stored in the second space (second space of PB10) of the second physical areas 142.

In such a case, since the control operation component 134 performs a read operation on the first second-compressed data COMP_DATA2<0:3> through the first second-logical information LOI2<PB3>, the first second-logical information LOI2<PB3> stored in the second space (second space of PB10) of the second physical areas 142 is invalidated, so that the first second-compressed data COMP_DATA2<0:3> stored in the one physical area PB3 set as the second storage area indicated by the first second-logical information LOI2<PB3> may also be invalidated.

In addition, the control operation component 134 may invalidate the second space (second space of PB10) of the second physical areas 142 and the first second-storage area PB<3> in response to the command requesting the invalidation of the first second-logical information LOI2<PB3>, switch the first second-storage area PB<3> into a free area, store the information FBL<PB3> corresponding to the first second-storage area PB<3> in the free area queue 136, and put the information FBL<PB3> into the free area information.

Accordingly, in the free area queue 136, the information FBL<PB3> moved to the free area queue 136 in FIG. 3H may be managed as free area information, together with the information FBL<PB4:5, PB1, PB6:9> remaining in the free area queue 136 before FIG. 3H. In such a case, the information FBL<PB4:5, PB1, PB6:9> remaining in the free area queue 136 before FIG. 3H may be aligned to be referenced with a higher priority than the information FBL<PB3> moved to the free area queue 136 after FIG. 3H.

Referring to FIG. 3I, it can be seen that some of the free area information stored in the free area queue 136 is moved to the management area of the volatile memory 140 for management.

Specifically, the internal memory 137 included in the control operation component 134 may have a relatively small overall storage space instead of having a higher operating speed than the volatile memory 140. Accordingly, when the size of the free area queue 136 allocated to the internal memory 137 exceeds an appropriate size, the free area information stored in the free area queue 136 may be moved to the management area of the volatile memory 140 for management.

More specifically, all free area information may be stored in the free area queue 136 after FIG. 3H. In addition, in the volatile memory 140, the management area may be released.

In such a state, the control operation component 134 may set some of the first physical areas 141 of the volatile memory 140 as management areas, and then move some of the free area information stored in the free area queue 136 for management.

According to an embodiment, free area information on a total of eight free areas PB<4:5, 1, 6:9, 3> may be stored in the free area queue 136 after FIG. 3H. The control operation component 134 may refer to the free area information stored in the free area queue 136, and set, as a management area, the physical area PB4 of the volatile memory 140 corresponding to one piece of information FBL<PB4> among the eight pieces of information FBL<PB4:5, PB1, PB6:9, PB3>. In such a case, the one physical area PB4 set as the management area may be set as the header HEAD and the tail TAIL, and ‘null’ may be set in the next information NEXT.

Subsequently, the control operation component 134 may refer to the free area information stored in the free area queue 136, move four pieces of information FBL<PB5, PB1, PB6:7> of seven pieces of information FBL<PB5, PB1, PB6:9, PB3> to the one physical area PB4 set as the management area and store the four pieces of information FBL<PB5, PB1, PB6:7>, and manage only the remaining three pieces of information FBL<PB8:9, PB3> in the free area queue 136.

The embodiments of the present disclosure described above are not limited by the aforementioned embodiments and the accompanying drawings, and it will be apparent to those skilled in the art to which the present disclosure pertains that various replacements, modifications, and changes can be made without departing from the technical spirit of the present disclosure. Furthermore, the embodiments may be combined to form additional embodiments.

What is claimed is:

1. A storage device comprising:
a volatile memory comprising a plurality of physical areas;
a compression operation component configured to compress write data at a first ratio to generate first compressed data; and
a control operation component configured to
set the plurality of physical areas included in the volatile memory as first physical areas and second physical areas,
set a first number of physical areas among the first physical areas as first storage areas to manage the first number of physical areas in a form of a linked list,
store the first compressed data in the first storage areas, and
store, in the second physical areas, first logical information indicating an area set as a header, among the first storage areas.

2. The storage device of claim 1,
wherein the compression operation component is configured to compress the write data at a second ratio to generate second compressed data, and
wherein the control operation component is configured to
set a second number of physical areas among the first physical areas as second storage areas to manage the second number of physical areas in a form of a linked list,
store the second compressed data in the second storage areas, and
store, in the second physical areas, second logical information indicating an area set as a header, among the second storage areas.

3. The storage device of claim 2,
wherein each of the plurality of physical areas includes a plurality of storage spaces, and
wherein the control operation component is configured to:
store the first compressed data in some of the plurality of storage spaces included in each of the first number of physical areas set as the first storage areas, and store information for managing the linked list of the first storage areas in remaining storage spaces;
store the second compressed data in some of the plurality of storage spaces included in each of the second number of physical areas set as the second storage areas, and store information for managing the linked list of the second storage areas in remaining storage spaces; and
store one of the first and second logical information in each of the plurality of storage spaces included in each of the second physical areas.

4. The storage device of claim 3, wherein, whenever the first or second logical information is generated, the control operation component is configured to search for an empty space among the plurality of storage spaces included in the second physical areas, and store the first or second logical information.

5. The storage device of claim 4, wherein the control operation component is configured to:
set some of the second physical areas as first selection areas, and set remaining physical areas as second selection areas;
search, whenever the first logical information is generated, for an empty space among a plurality of storage spaces included in the first selection area, and store the first logical information; and
search, whenever the second logical information is generated, for an empty space among a plurality of storage spaces included in the second selection area, and store the second logical information.

6. The storage device of claim 3, wherein, to store free area information on free areas capable of storing data among the first physical areas, the control operation component is configured to set some of a current number of the free areas as management areas, and manage some of the areas set as the management areas, in a form of a linked list.

7. The storage device of claim 6, wherein the control operation component is configured to:
select the first number of areas among the free areas as the first storage areas based on the free area information, and invalidate, in the management area, information corresponding to the first storage areas, among the free area information; and
select the second number of areas among the free areas as the second storage areas based on the free area information, store the second compressed data in the selected second storage areas, generate the second logical information, store the second logical information in the second physical areas, and invalidate, in the management area, information corresponding to the second storage areas among the free area information.

8. The storage device of claim 7, wherein the control operation component is configured to:
invalidate each of the first logical information and the first compressed data in response to a command requesting invalidation of the first logical information, switch the first storage area to the free area, and put the free area into the free area information; and
invalidate each of the second logical information and the second compressed data in response to a command requesting invalidation of the second logical information, switch the second storage area to the free area, and put the free area into the free area information.

9. The storage device of claim 8, wherein the control operation component is configured to check the current number of the free areas among the first physical areas, and vary, according to the checked current number of free areas, a number of areas to be set as the management areas, among the current number of the free areas.

10. The storage device of claim 9,
wherein the control operation component comprises an internal memory including a space for storing a free area queue and having an operating speed higher than the volatile memory,
wherein the control operation component is configured to move partial information of the free area information to the free area queue to manage the moved information.

11. The storage device of claim 10, wherein the control operation component is configured to:
move the partial information to the free area queue;
switch an area storing the partial information, among the first physical areas set as the management areas into the free area;
move information on the switched free area to the free area queue; and
manage the moved information together with the partial information.

12. An operating method of a storage device including a volatile memory, the operating method comprising:
setting a plurality of physical areas included in the volatile memory as first physical areas and second physical areas; and
storing first compressed data obtained by compressing write data at a first ratio in first storage areas for managing the first number of physical areas among the first physical areas in a form of a linked list, and storing, in the second physical areas, first logical information indicating an area set as a header, among the first storage areas.

13. The operating method of claim 12, further comprising:
storing second compressed data obtained by compressing the write data at a second ratio in second storage areas for managing the second number of physical areas among the first physical areas in a form of a linked list, and storing, in the second physical areas, second logical information indicating an area set as a header, among the second storage areas.

14. The operating method of claim 13, wherein the each of the plurality of physical areas includes a plurality of storage spaces, and
storing the first compressed data obtained by compressing the write data at the first ratio comprises:
storing the first compressed data in some of the plurality of storage spaces included in each of the first number of physical areas set as the first storage areas, and storing information for managing the linked list of the first storage areas in remaining storage spaces;
generating the first logical information indicating the area set as the header, among the first storage areas; and
searching for an empty space among the plurality of storage spaces included in the second physical areas and storing the first logical information.

15. The operating method of claim 14, wherein storing the second compressed data obtained by compressing the write data at the second ratio comprises:
storing the second compressed data in some of the plurality of storage spaces included in each of the second number of physical areas set as the second storage areas, and storing information for managing the linked list of the second storage areas in remaining storage spaces;
generating the second logical information indicating the area set as the header, among the second storage areas; and
searching for an empty space among the plurality of storage spaces included in the second physical areas and storing the second logical information.

16. The operating method of claim 15, further comprising setting some of the second physical areas as first selection areas and setting remaining physical areas into second selection areas,
wherein an empty space is searched for among a plurality of storage spaces included in the first selection area and the first logical information is stored, and
wherein an empty space is searched for among a plurality of storage spaces included in the second selection area and the second logical information is stored.

17. The operating method of claim 15, further comprising:
setting, to store free area information on free areas capable of storing data among the first physical areas, some of a current number of the free areas as management areas; and
managing some of the areas set as the management areas, in a form of a linked list.

18. The operating method of claim 17,
wherein storing the first compressed data obtained by compressing the write data at the first ratio further comprises:
selecting the first storage areas from the free areas based on the free area information; and
invalidating, in the management area, information corresponding to the first storage areas among the free area information after storing the first compressed data, and
wherein storing the second compressed data further comprises:
selecting the second storage areas from the free areas based on the free area information; and
invalidating, in the management area, information corresponding to the second storage areas among the free area information after storing the second compressed data in some of the plurality of storage spaces.

19. The operating method of claim 18,
wherein storing the first compressed data obtained by compressing the write data at the first ratio further comprises:
invalidating each of the first logical information and the first compressed data in response to a command requesting invalidation of the first logical information; and
switching the first storage area to the free area and putting the free area into the free area information, and
wherein storing the second compressed data further comprises:
invalidating each of the second logical information and the second compressed data in response to a command requesting invalidation of the second logical information; and
switching the second storage area to the free area and putting the free area into the free area information after invalidating each of the second logical information and the second compressed data.

20. The operating method of claim 19, wherein, managing some of the areas set as the management areas comprises:
checking the current number of the free areas among the first physical areas; and
varying the number of areas to be set as the management areas among the current number of the free areas according to the checked current number of free areas.

21. The operating method of claim 20,
wherein the storage device further includes an internal memory having an operating speed higher than the volatile memory, physically separate, and including a space for storing a free area queue, and
wherein the operating method further comprises moving partial information of the free area information to the free area queue to manage the moved information.

22. The operating method of claim 21, further comprises:
moving the partial information to the free area queue;
switching an area storing the partial information, among the first physical areas set as the management areas into the free area;
moving information on the switched free area to the free area queue; and
managing the moved information together with the partial information.
